(19) United States
(12) Patent Application Publication
(10) Pub. No.: US 2009/0009863 A1
(43) Pub. Date: Jan. 8, 2009

(54) Anti-reflection film, method of producing the same, polarizing plate, liquid crystal display

(75) Inventor: Kazuhiro Nakamura, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/659,097

(22) PCT Filed: Aug. 2, 2005
(86) PCT No.: PCT/JP2005/014492

§ 371 Date: Feb. 1, 2007

(30) Foreign Application Priority Data
Aug. 3, 2004 (JP) 2004-226897

(51) Int. Cl. G02B 5/30; F21V 9/00; B32B 5/16; B32B 5/00; B32B 27/00; C09K 19/38; B05D 5/06

(52) U.S. Cl. 359/485; 252/582; 428/337; 428/411.1; 427/164; 428/213

(57) ABSTRACT

An anti-reflection film is provided and has a transparent support and a low refractive index layer having a lower refractive index than that of the transparent support. The transparent support is produced by casting and drying a dope containing a polymer and a solvent over a belt-shaped support, in which the dope is stretched under conditions: (a) a maximum stress of the dope in a casting crosswise direction is from 1 MPa to 200 MPa; and (b) a ratio (Sy/Sx) of a stress Sy in the casting crosswise direction to a stress Sx in a dope conveying direction perpendicular to the casting crosswise direction is from 2 to not 50 during the drying.

### TECHNICAL FIELD

The present invention relates to an anti-reflection film and more particularly to an anti-reflection film comprising as a substrate a transparent support having an improved flatness, a method of producing the same, a polarizing plate, and a liquid crystal display.

### BACKGROUND ART

An anti-reflection film is disposed on the surface of the screen of various image displays such as liquid crystal display (LCD), plasma display panel (PDP), electroluminescence display (ELD) and cathode ray tube display (CRT). An anti-reflection film is disposed also on the lens of glasses or cameras. As such an anti-reflection film there has heretofore been normally used a multi-layer film obtained by laminating thin transparent films of metal oxide. The reason why a plurality of thin transparent films are used is to prevent the reflection of light rays in as wide wavelength range as possible in the visible light range. The thin transparent film of metal oxide is formed by chemical vapor deposition method (CVD) or physical vapor deposition method (PVD), particularly vacuum deposition method or sputtering method, which is one of the physical vapor deposition methods. The thin transparent film of metal oxide has excellent optical properties as an anti-reflection film, but the film making method involving vacuum deposition or sputtering has a low productivity and thus is not suitable for mass production.

A method which comprises forming an anti-reflection film by the coating of a particulate inorganic material instead of vacuum deposition has been proposed. JP-B-60-59250 discloses an anti-reflection layer comprising micropores and a particulate inorganic material. The anti-reflection layer is formed by coating. The micropores are formed by subjecting the coating anti-reflection layer to treatment with an activated gas, and then allowing the activated gas to leave the layer. JP-A-59-50401 discloses an anti-reflection film comprising a support, a high refractive index layer and a low refractive index layer stacked in this order. JP-A-59-50401 also discloses an anti-reflection film comprising a middle refractive index layer provided interposed between the support and the high refractive index layer. The low refractive index layer is formed by coating a polymer or a particulate inorganic material.

Since the optical interference layer in the anti-reflection film is formed by coating a coating solution to a thickness as very small as about ½ to ¼ of the visible light wavelength, unevenness in thickness on the order of few nanometers causes the occurrence of a great deviation of film thickness. Further, even when there is a slight unevenness in thickness of various layers, the resulting unevenness in color causes a drastic shift of tint which can be visually detected as an unevenness. Therefore, it is very important to provide a coating method capable of accurately controlling the film thickness.

As a method of coating an anti-reflection film coating solution there has heretofore been mainly used a dip coating method, microgravure coating method, reverse roll coating method or the like. The dip coating method is unavoidably subject to oscillation of coating solution in the liquid reservoir tank that causes the occurrence of stepwise unevenness. In the reverse roll coating method and microgravure coating method, the eccentricity or deflection of rolls related to coating can cause the occurrence of stepwise unevenness. Further, in the microgravure coating method, the working precision of gravure roll or the change of gravure rolls or blade with time due to contact of blade with gravure rolls can cause the change of spread. Moreover, since these coating methods involve a post-measurement process, it is made relatively difficult to assure a stable film thickness. Therefore, these coating methods can difficulty attain coating at a rate of not lower than a certain value. Though attaining a high productivity as compared with vacuum vapor deposition method, these coating methods cannot fully make the best use of the high productivity characteristic to spreading.

JP-A-7-151904 proposes a method which comprises coating an anti-reflection film coating solution using a die coating method.

The die coating method involves a post-measurement process and thus is advantageous in that the resulting coat layer has a stable thickness. However, when a commonly used die configuration is used to perform coating, only a high speed which is about the same as that of the aforementioned various coating methods can be realized. In some detail, when a coating solution for thin layer such as anti-reflection layer is coated, remarkable unevenness in film thickness occurs in the direction perpendicular to and parallel to the conveying direction of the transparent support, making it difficult to keep the film thickness stable. In JP-A-7-151904, the die configuration is not specifically limited. An ordinary die is assumed in JP-A-7-151904. Thus, no special proposes are not made on the shape and other factors of die. On the other hand, JP-A-2003-200097 discloses that proper design of the configuration of die makes it possible to coat a thin layer coating solution with a good precision. The use of this method makes it possible to coat a coating solution for thin layer such as anti-reflection layer with a good precision.

On the other hand, it is known that in all the aforementioned coating methods, the flatness of the support has a great effect on the unevenness in thickness of various layers. For example, in the case where the clearance between the support and the coating solution supplying portion causes the change of spread as in die coating method, the wet spread varies from indentation to raised portion on the support. Also in the case where the size of meniscus in the coating portion has an effect on the spread as in microgravure coating method and wire bar coating method, when the flatness of the support is insufficient, the meniscus is distorted, causing the occurrence of unevenness in the surface conditions of the coat layer. In all the coating methods, the coating solution which has been spread flows according to the surface roughness of the support in the initial stage of drying, causing the occurrence of unevenness.

The transparent support in the form of roll that can be handled as a web which is used as a substrate for the anti-reflection film of the invention is produced by a solution film making method which comprises casting a dope having raw materials dissolved in a solvent or a solution film making method which comprises casting a melt obtained by heating the raw materials. As compared with a polyethylene terephthalate film or the like produced by a solution film making method, the transparent support produced by a solution film making method with triacetyl cellulose or the like as used in liquid crystal display, etc. shows remarkable streak-like roughness defect extending longitudinally (called “wrinkling”) that can have an adverse effect particularly on the uniformity in thickness of anti-reflection layer. Referring to solution film making method, when a dope having raw materials dissolved in a solvent is casted over a belt-shaped or drum-shaped support and dried, a large amount of solvent is evaporated from the surface of the film, causing the film to reduce its volume and shrink. When the film is allowed to freely shrink, the film shrinks not a little unevenly and thus loses its flatness. The loss of flatness causes the occurrence of the aforementioned streak-like roughness defect. It has thus been heretofore known proposed that the film be positively stretched in the casting crosswise direction (hereinafter referred to as “crosswise direction”) to assure mainly the flatness of the film at the drying step (see, e.g., JP-A-11-048271).

As previously mentioned, in all the aforementioned coating methods of production of anti-reflection film involving wet coating, the flatness of the support has a great effect on the unevenness in thickness of various layers. A study made it obvious that the flatness of the support can raise a critical problem particularly with die coating method, which is excellent in adaptability to high speed coating.

### DISCLOSURE OF THE INVENTION

An object of an illustrative, non-limiting embodiment of the invention is to solve the aforementioned problem and to provide an anti-reflection film having a high uniformity in thickness at a high productivity. Another object of an illustrative, non-limiting embodiment of the invention is to provide a polarizing plate and a liquid crystal display including the anti-reflection film.

The inventors made extensive studies of solution to the aforementioned problems. As a result, it was found that the aforementioned objects of the invention can be accomplished by improving the device and conditions of making the transparent support to improve flatness, improving the shape of the end of the coating portion of the coating device such that the anti-reflection film can be spread by die coating solution, which is excellent in productivity, particularly by combining the two methods. The invention has thus been worked out.

In other words, the aforementioned aims of the invention can be accomplished by the following constitutions.

1. An anti-reflection film comprising:

a transparent support; and

a low refractive index layer having a lower refractive index than that of the transparent support,

wherein the transparent support is produced by casting and drying a dope comprising a polymer and a solvent over a belt-shaped support, in which the dope is stretched under conditions:

(a) a maximum stress of the dope in a casting crosswise direction is from 1 MPa to 200 MPa; and

(b) a ratio (Sy/Sx) of a stress Sy in the casting crosswise direction to a stress Sx in a dope conveying direction perpendicular to the casting crosswise direction is from 2 to not 50 during the drying.

2. The anti-reflection film as defined in Clause 1, wherein the transparent support is treated with heat at a temperature of from 50° C. to 180° C. and for 1 second to 30 seconds after being stretched.
3. The anti-reflection film as defined in Clause 1 or 2, wherein a residual solvent content during stretching of the transparent support in the casting crosswise direction is from 3% by weight to 45% by weight.
4. The anti-reflection film as defined in any one of Clauses 1 to 3, wherein the transparent support is a cellulose acylate film having a thickness of from 40 μm to 120 μm.
5. The anti-reflection film as defined in any one of Clauses 1 to 4, wherein

the low refractive index layer is a cured layer formed by coating and curing a composition comprising at least a curable composition, the curable composition comprising mainly a fluorine-containing polymer containing: fluorine atoms in an amount of from 35 to 80% by weight; and a crosslinkable or polymerizable group,

the fluorine-containing polymer is a copolymer containing a fluorine-containing vinyl monomer polymerizing unit, a polymerizing unit having a (meth)acryloyl group in a side chain thereof, the copolymer having a main chain of only carbon atoms, and

the low refractive index layer has a refractive index of from 1.30 to 1.55.

6. The anti-reflection film as defined in any one of Clauses 1 to 4, wherein the low refractive index layer is a cured layer formed by coating and curing a curable composition comprising:

(A) a fluorine-containing polymer,

(B) a particulate inorganic material having an average particle diameter of from 30% to 150% of a thickness of the low refractive index layer and a hollow structure having a refractive index of from 1.17 to 1.40; and

(C) at least one of a hydrolyzate and a partial condensate of an organosilane represented by formula (1), the organosilane being produced in the presence of an acid catalyst or a metal chelate compound:

(R¹⁰)ₘSi(X)₄₋ₘ (1)

wherein R¹⁰ represents a substituted or unsubstituted alkyl or aryl group; X represents a hydroxyl group or hydrolyzable group; and m represents an integer of from 1 to 3.
7. The anti-reflection film as defined in any one of Clauses 1 to 4, wherein

the low refractive index layer is a cured layer formed by coating and curing a curable composition comprising at least one of a hydrolyzate of a compound represented by formula (2) and a dehydration condensate thereof:

(R²)ₙSi(Y)₄₋ₙ (2)

wherein R² represents a substituted or unsubstituted alkyl group, partly or fully fluorine-substituted alkyl group or substituted or unsubstituted aryl group; Y represents a hydroxyl group or hydrolyzable group; and n represents an integer of from 0 to 3, and

the low refractive index layer has a refractive index of from 1.30 to 1.55:

8. The anti-reflection film as defined in any one of Clauses 1 to 7, which further comprises at least one layer of a hard coat layer having no light-scattering properties and a hard coat layer having light-scattering properties, the at least one layer being between the transparent support and the low refractive index layer.
9. A method of producing an anti-reflection film as defined in any one of Clauses 1 to 8, which comprises:

coating a coating solution of at least one anti-reflection layer to a surface of a transparent support from a slot of an end lip of a slot die, wherein a land of the end lip is close to the surface of the transparent support, and the transparent support is continuously running and supported over a backup roller,

wherein the land of the end lip comprises: an upstream lip land disposed upstream from the slot along a running direction of a web; and a downstream lip land disposed downstream form the slot along a running direction of the transparent support,

the downstream lip land has a length in the running direction of from 30 μm to 100 μm, and

a gap between the downstream lip land and the web is from 30 μm to 120 μm greater than that between the upstream lip land and the web during the coating.

10. A polarizing plate comprising: a polarizing film; and two surface protective films, at least one of the two surface protective films comprising an anti-reflection film defined in any one of Clauses 1 to 8 or an anti-reflection film produced by a method of producing an anti-reflection film defined in Clause 9.
11. The polarizing plate as defined in Clause 10, wherein

one film of the at least two surface protective films comprises the anti-reflection film,

the other film of the at least two surface protective films is an optical compensation film having an optical compensation layer comprising an optically anisotropic layer on an opposite side of the other film from the polarizing film, and

the optically anisotropic layer comprises a compound having a discotic structural unit, wherein a disc surface of the discotic structure unit is disposed obliquely to a surface of the other film, and an angle of the disc surface of the discotic structure unit with respect to the surface of the other film changes in a depth direction of the optically anisotropic layer.

12. A liquid crystal display comprising at least one sheet of polarizing plate defined in Clause or 11.

The anti-reflection film of the invention includes as a substrate a transparent support having an improved flatness that eliminates unevenness in the spread of anti-reflection layer due to roughness on the support and thus forms an anti-reflection film having inhibited color unevenness. Further, the combination of the anti-reflection film of the invention with the production method of the invention involving die coating makes it possible to provide an excellent productivity (adaptability to high speed coating) in addition to elimination of coating unevenness.

### BRIEF DESCRIPTION OF THE DRAWINGS

FIG. 1 is a sectional view diagrammatically illustrating the layer configuration of an illustrative, non-limiting embodiment of an anti-reflection film of the invention;

FIG. 2 is a sectional view diagrammatically illustrating the layer configuration of an illustrative, non-limiting embodiment of a multi-layer anti-reflection film of the invention;

FIG. 3 is a schematic diagram of a film making line for use in the film-making of a transparent support solution of the invention;

FIG. 4 is a schematic plan view of a tenter device for use in the film-making of a transparent support solution of the invention;

FIG. 5 is a schematic diagram of another embodiment of the film making line for use in the film-making of a transparent support solution of the invention;

FIG. 6 is a sectional view of a coater comprising a slot die embodying the invention;

FIG. 7A illustrates a sectional shape of a slot die 13 of the invention and FIG. 7B illustrates a sectional shape of a related art slot die 30;

FIG. 8 is a perspective view illustrating a slot die used at a coating step embodying the invention and its periphery;

FIG. 9 illustrates an example of sectional view illustrating a pressure-reducing chamber 40 and a web 12 which are disposed close to each other in a coating device in die coating method, which is an illustrative, non-limiting embodiment of a coating method in the invention; and

FIG. 10 illustrates another example of sectional view illustrating a pressure-reducing chamber 40 and a web 12 which are disposed close to each other in a coating device in die coating method, which is a preferred coating method in the invention.

### DETAILED DESCRIPTION OF THE INVENTION

In the present specification, in the case where the numerical values indicate physical values, properties or the like, the term “(value 1) to (value 2)” as used herein is meant to indicate “not smaller than (value 1) to not greater than (value 2)”. The term “(meth)acryloyl” as used herein is meant to indicate “at least any of acryloyl and methacryloyl”. This can apply to “(meth)acrylate”, “(meth)acrylic acid”, etc. In the case where hydrogen atoms are substituted by atoms other than hydrogen atom, these atoms other than hydrogen atom are considered to be substituents for convenience.

The basic configuration of an exemplary embodiment of the anti-reflection film of the invention will be described hereinafter in connection with the attached drawings.

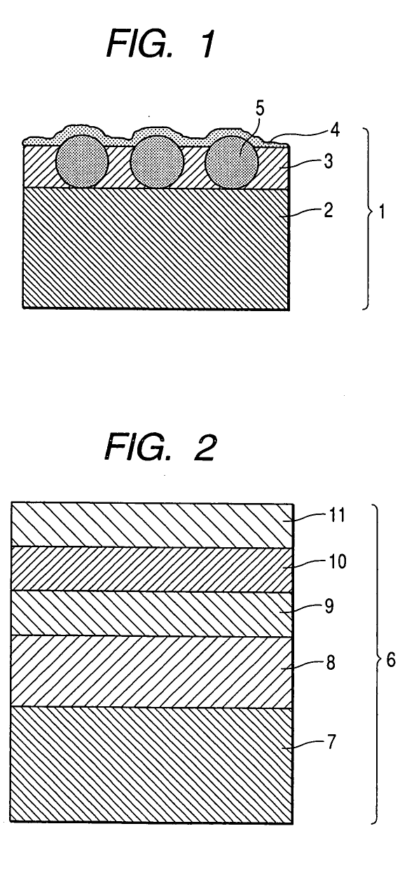

FIG. 1 is a sectional view diagrammatically illustrating an exemplary embodiment of the anti-reflection film of the invention.

An anti-reflection film 1 of the embodiment shown in FIG. 1 includes a transparent support 2, a hard coat layer 3 formed on the transparent support 2, and a low refractive index layer 4 formed on the hard coat layer 3.

An exemplary embodiment of the hard coat layer 3 is provided with light-scattering properties for the purpose of providing anti-glare properties, eliminating the glare of display and improving viewing angle properties. In order to provide the hard coat layer 3 with light-scattering properties, the light-transmitting resin preferably comprises a particulate light-transmitting material incorporated therein.

The refractive index of the various layers constituting the anti-reflection film of the invention preferably satisfy the following relationship.

Refractive index of hard coat layer>refractive index of transparent support>refractive index of low refractive index layer

In the embodiment, the hard coat layer includes one layer. However, the hard coat layer may include a plurality of layers, e.g., two to four layers. The hard coat layer may be provided directly on the transparent support as in the embodiment but may be provided on the transparent support with other layers such as antistatic layer and moistureproof layer interposed therebetween.

In order to provide the anti-reflection film of the invention with anti-glare properties, the surface roughness of the anti-reflection film is preferably designed such that the central line-average roughness Ra is from 0.08 to 0.40 μm, the ten point-average roughness Rz is 10 times or less Ra, the average mountain-valley distance Sm is from 1 to 100 μm, the standard deviation of height of raised portions from the deepest valley of roughness is 0.5 μm or less, the standard deviation of average mountain-valley distance Sm with central line as reference is 20 μm and the proportion of surfaces having an inclination angle of from 0 to 5 degrees is 10% or less to attain sufficient anti-glare properties and visually uniform matte look to advantage.

Further, it is preferred that the tint of reflected light under C light source comprise a* value of from −2 to 2 and b* value of from −3 to 3 and the ratio of minimum reflectance to maximum reflectance in the wavelength range of from 380 nm to 780 nm be from 0.5 to 0.99 to make the tint of reflected light neutral. Moreover, when b* value of transmitted light under C light source is from 0 to 3, the yellow tint of white display developed when the anti-reflection film is applied to display is reduced to advantage. Further, the standard deviation of brightness distribution measured on the anti-reflection film with a lattice having a size of 120 μm×40 μm put interposed between a planer light source and the anti-reflection film is preferably 20 or less to eliminate glare developed when the anti-reflection film of the invention is applied to a high precision panel.

Further, the anti-reflection film of the invention preferably has optical properties such that the specular reflectance is 2.5% or less, the transmittance is 90% or more and the 60° gloss is 70% or less to inhibit the reflection of external light rays and hence improve the viewability. In order to inhibit the glare on high precision LCD panel and eliminate blurring of letters, etc., it is preferred that the haze be from 20% to 50%, the ratio of internal haze to total haze be from 0.3 to 1, the drop from haze of the laminate up to the hard coat layer to haze developed after the formation of the low refractive index layer be 15% or less, the sharpness of transmitted image at a comb width of 0.5 mm be from 15% to 50% and the ratio of transmittance of light transmitted at right angle to light transmitted obliquely at an angle of 2 degrees from the right angle be from 1.5 to 5.0.

FIG. 2 is a sectional view diagrammatically illustrating another exemplary embodiment of the anti-reflection film of the invention. In the embodiment, a multi-layer anti-reflection film 6 comprising an anti-reflection layer including three layers, i.e., middle refractive index layer 9 having a higher refractive index than that of the transparent support 7 and the hard coat layer 8 and a lower refractive index than that of the high refractive index layer, high refractive index layer 10 having the highest refractive index in all the layers and low refractive index layer 11 having the lowest refractive index in all the layers. The embodiment of anti-reflection film has an average reflectance as low as 0.5% or less and thus can be preferably used for television and monitor in particular.

The embodiment of the anti-reflection film preferably exhibits a specular reflectance of 0.5% or less and a transmittance of 90% or more to inhibit the reflection of external light rays and improve the viewability thereof.

The transparent support of the invention will be further described hereinafter.

### (Transparent Support)

### <Polymer>

The polymer to be used in the transparent support of the invention is not specifically limited. Specific examples of the polymer include polyamides, polyolefins, norbornenes, polystyrenes, polycarbonates, polysulfones, polyacrylic acids, polymethacrylic acids, polyether ether ketones (PEEK), polyvinyl alcohols, polyvinyl acetates, and cellulose derivatives (e.g., lower aliphatic acid ester of cellulose, cellulose acylate).

The polymer to be used herein is preferably a cellulose derivative which exhibits a small optical anisotropy when filmed, preferably a cellulose acylate, more preferably a cellulose acetate, even more preferably a cellulose triacetate (TAC), most preferably a cellulose triacetate having an acetylation degree of from 59.5% to 62.5%.

### <Solvent>

Examples of the solvent for dissolving the aforementioned cellulose acylate therein to prepare a dope include halogenated hydrocarbons (e.g., dichloromethane, chloroform), esters (e.g., methyl formate, methyl acetate, ethyl acetate, amyl acetate, butyl acetate), ethers (e.g., dioxane, dioxolane, tetraliydrofurane, diethyl ether, methyl-t-butyl ether), aromatic hydrocarbons (e.g., benzene, toluene, xylene), aliphatic hydrocarbons (e.g., hexane, heptane), alcohols (e.g., methanol, ethanol, n-butanol), and ketones (e.g., cyclopentanone, acetone, methyl ethyl ketone, cyclohexanone). These solvents may be used singly or in admixture.

In the case where TAC is used as polymer in the invention, halogenated hydrocarbons such as dichloromethane or mixed solvents comprising methyl acetate as a main solvent are preferably used. The former solvent has heretofore been normally used in the cast-filming of TAC and has been known to be excellent in adaptability to filming at high speed. On the other hand, methyl acetate, unlike halogenated hydrocarbons such as dichloromethane, is excellent in environmental protection and thus can be easily disposed off after filming to advantage. The percent composition of methyl acetate in the mixed solvent is preferably 60% by weight or more, more preferably 75% by weight or more. Examples of the subsidiary solvents in the mixed solvent include solvents having an excellent affinity for methyl acetate such as ketones (e.g., cyclopentanone, acetone) and alcohols (e.g., methanol, ethanol, n-butanol). However, the invention is not limited to these solvents.

### <Additives>

In order to provide the film thus prepared with desirable properties, the dope may comprise additives incorporated therein. Examples of these additives include plasticizers (e.g., triphenyl phosphate, biphenyl diphenyl phosphate, dipentaerythritol hexaacetate, ditrimethylolpropane tetraacetate), ultraviolet absorbers (e.g., oxobenzophenone-based compound, benzotriazole-based compound), matting agents (e.g., particulate silicon dioxide), thickening agents, and oil gelling agents. However, the invention is not limited to these additives. These additives may be added to the polymer during the dissolution of the polymer in a solvent or may be added to the dope prepared in an in-line system during filming. These additives may be added as they are or in the form of solution in a solvent.

A film made of a dope comprising a material having acid properties (hereinafter referred to as “acid material”) incorporated therein has an excellent peelability. Examples of the acid material include inorganic acids (e.g., hydrochloric acid), organic acids (e.g., phenol), organic carboxylic acids (e.g., acetic acid, lactic acid), polyvalent organic carboxylic acids (e.g., citric acid, tartaric acid), and polyvalent organic carboxylic acid derivatives. However, the invention is not limited to these acid materials. Examples of the basic skeleton of the polyvalent organic carboxylic acid derivatives include aliphatic hydrocarbon-based skeletons (e.g., straight-chain saturated aliphatic hydrocarbon, branched saturated aliphatic hydrocarbon, straight-chain unsaturated aliphatic hydrocarbon, branched unsaturated aliphatic hydrocarbon, monocyclic aliphatic hydrocarbon, aromatic aliphatic hydrocarbon, condensed polycyclic aliphatic hydrocarbon, bridged cyclic aliphatic hydrocarbon, spiro aliphatic hydrocarbon, heterocyclic aliphatic hydrocarbon, terpene), aromatic hydrocarbon-based skeletons (e.g., aromatic hydrocarbon, condensed polycyclic hydrocarbon), and heterocyclic skeletons (e.g., heterocyclic group). The invention is not limited to these skeletons. The amount of the acid material to be added is not specifically limited but is preferably from 200 ppm to 800 ppm by weight based on the weight of the polymer so far as the optical properties of the film cannot be affected.

### <Preparation of Dope>

The dope and necessary additives which have been added to the solvent are then dissolved in the solvent by any of known dissolving methods to produce a dope. This dope is then normally filtered to remove foreign matters. For filtration, any known filtering material such as filter paper, filter cloth, nonwoven cloth, metal mesh, sintered metal and porous plate may be used. The filtration of the dope makes it possible to remove foreign matters and undissolved matters therefrom and hence eliminate defects due to foreign matters in the film.

Further, the dope which has been once subjected to dissolution may be heated to further enhance solubility.

Examples of the heating method include a method which comprises heating a dope with stirring in a stationary tank, and a method which comprises heating a dope while being moved using various heat exchangers such as multi-pipe type heat exchanger and jacket piping with stationary mixer. The heating step may be followed by a cooling step. The interior of the device may be pressurized so that the dope is heated to a temperature of not lower than the boiling point thereof. When the dope has been subjected to these treatments, undissolved matters having a low solution can be fully dissolved to reduce the content of foreign matters in the film and eliminate the burden of filtration.

<Method of Making Film from Solution>

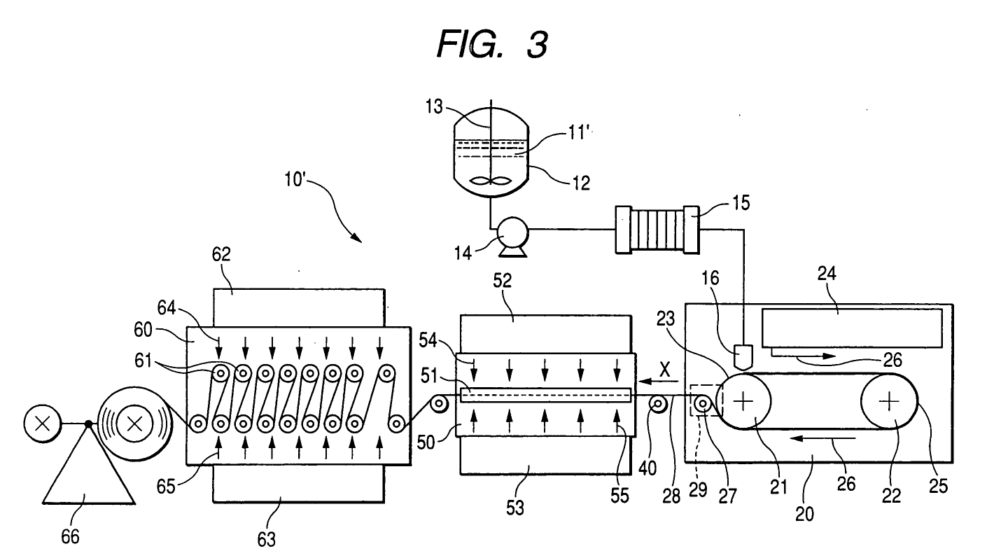

FIG. 3 illustrates an exemplary embodiment of the film making line 10′ for use in the film making of solution of the invention. A dope 11′ is put in a mixing tank 12. By way of example, the dope 11′ is shown comprising a cellulose acylate as a polymer and a solvent mainly composed of methyl acetate. The mixing tank 12 is equipped with an agitating blade 13 for rendering the dope 11′ uniform. The agitating blade 13 is rotated by a motor (not shown) to agitate the dope 11′. The dope 11′ is fed into a filtering device 15 at a constant flow rate by a feed pump 14. The dope 11′ which has been filtered through the filtering device 15 to remove impurities is then passed to a casting die 16.

The casting die 16 is provided in a casting chamber 20. Provided downstream from the casting die 16 is a casting band 23 which makes endless rotation with the rotation of revolving rollers 21, 22. The casting chamber 20 preferably comprises a drying air supplier 24 provided therein. The dope 11′ is casted from the casting die 16 over the casting band 23 to form a cast film 25. The casting width is preferably 1,400 mm or more, more preferably 2,000 mm or more. During casting, the thickness of the dried film is preferably from 10 μm to 300 μm, more preferably from 40 μm to 120 μm. In order to accelerate the drying of the cast film 25, drying air 26 is preferably blown from the drying air supplier 24 onto the surface of the cast film 25. In the invention, the time during which the cast film 25 is conveyed over the casting band 23 is preferably from 2 to 4 minutes. In this case, when the drying air 26 is blown at a temperature of from 30° C. to 90° C. and a flow rate of 8 m/s to 12 m/s, the content of residual solvent described later can easily fall within a desired range. However, the invention is not limited to these ranges.

When drying proceeds until the cast film becomes self-supporting, the cast film is then peeled off the casting band 23 as a film 28 while being supported on the peeling roller 27. During this procedure, the control over the driving speed of the casting band 23 (hereinafter referred to as “casting speed”) V1 (m/s) and the conveying sped of the film thus peeled V2 (m/s) makes it possible to provide the film 28 with stress in the film conveying direction X (hereinafter referred to as “conveying direction”). The stress Sx (Pa) applied to the film 28 in the conveying direction X is measured by means of a tension meter 29. By predetermining the ratio (V2/V1) of conveying speed V2 (m/s) to casting speed V (m/s) to fall within a range of from more than 0.9 to less than 1.3, the stress Sx in the conveying direction can be desirable. However, the invention is not limited to this range. Moreover, in the invention, application of stress Sx in the conveying direction to the film 28 is not limited to that by the roller 40 provided in the transfer portion but may be accomplished by means of the tenter device 50 or by changing the conveying speed of the rollers provided downstream from the tenter device 50.

The film 28 is conveyed from the casting chamber 20 to the tenter chamber 50. In general, this zone is called transfer portion. Provided in the transfer portion is the roller 40 for conveying the film 28. While only one roller is shown in FIG. 3, there may be a plurality of rollers. In another embodiment, no rollers may be provided in the transfer portion.

The tenter chamber 50 comprises a tenter device 51 and drying air suppliers 52, 53 provided therein.

The film 28 is dried with drying air 54, 55 from the drying air suppliers 52, 53 while running through the tenter chamber 50. The film 28 is crosswise stretched by the tenter device 51. The content of residual solvent during stretching (see the following equation (1)) is adjusted by changing the running time in the casting chamber 20 or the flow rate and temperature of the drying air 26. Also in the tenter chamber 50, the content of residual solvent can be adjusted by changing the flow rate and temperature of the drying air 54, 55 supplied until stretching. The tenter device 51 will be further described later.

The film 28 which has been stretched and dried in the tenter chamber 50 is then conveyed to a drying chamber 60. The drying chamber 60 is equipped with a number of rollers 61 and drying air suppliers 62, 63 for supplying drying air. The film 28 runs over the rollers 61 through the interior of the drying chamber 60 where it is supplied with drying air 64, 65 the flow rate and temperature of which have been adjusted by the drying air suppliers 62, 63, respectively, so that it is further dried. Thereafter, the film 28 is wound by a winding machine 66 in the form of roll. The film 28 which has been delivered by the drying chamber 60 may be cooled, knurled or trimmed.

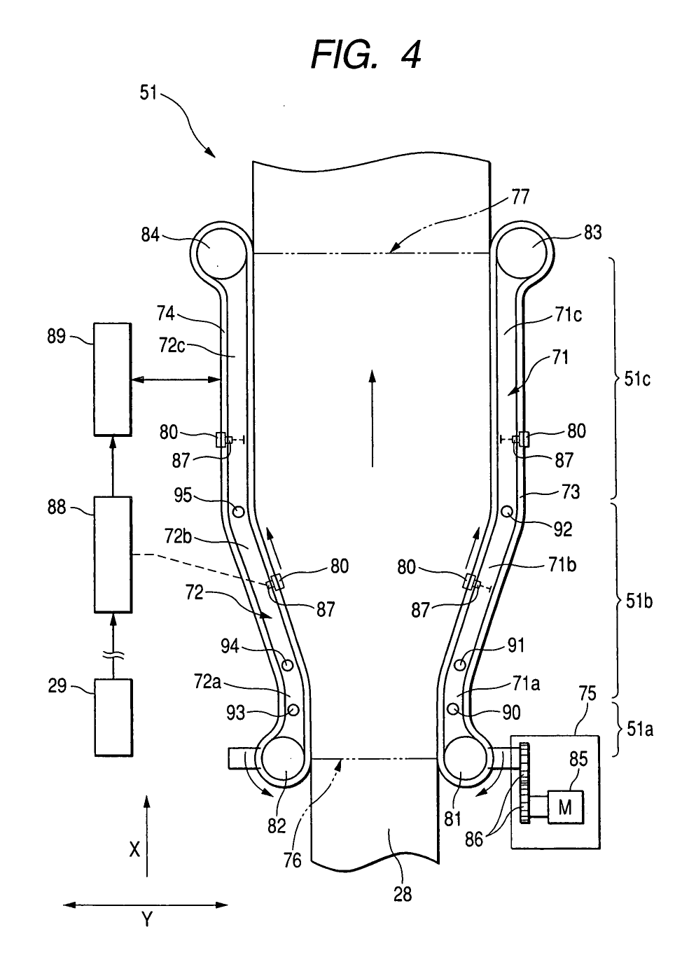

FIG. 4 is a schematic plan view of the tenter device 51. The tenter device 51 comprises a right rail 71, a left rail 72, endless chains 73, 74 guided by these rails 71, 72, respectively, and a chain driving portion 75. The tenter device 51 also comprises a preheating portion 51a, a stretching portion 51b and a heat treatment portion 51c aligned in this order from the inlet 76 to the outlet 77. The endless chains 73, 74 are each provided with film clips 80 for gripping the both sides of the film 28 (Only some of the film clips 80 are shown in FIG. 4 for illustration). The film clips 80 each move along the rails 71, 72 while gripping the edge of the film 28 to stretch the film 28 in the crosswise direction Y.

The endless chains 73, 74 extend between the driving sprockets 81, 82 and driven sprockets 83, 84, respectively. Over the zone between the sprockets 81, 82 and the sprockets 83, 84, the endless chains 73, 74 are guided by the right and left rails 71, 72, respectively. The driving sprockets 81, 82 each are provided on the inlet 76 side. The driving sprockets 81, 82 are rotationally driven by a motor 85 and a gear train 86 in the chain driving portion 75. The driven sprockets 83, 84 each are provided on the outlet 77 side.

The right rail 71 comprises an inlet portion 71a, a stretching portion 71b and an outlet portion 71c which are connected to each other with connecting shafts 90, 91, 92 in such an arrangement that they can be rotationally displaced. Similarly, the left rail 72 comprises an inlet portion 72a, a stretching portion 72b and an outlet portion 72c which are connected to each other with connecting shafts 93, 94, 95 in such an arrangement that they can be rotationally displaced. The various film clips 80 each are provided with a strain indicator 87. The measurements given by the strain indicator 87 are transmitted to a controller 88. The controller 88 then calculates the stress developed on the film 28 from the measurements. In order to provide a desired draw ratio on the stress thus calculated, the shift mechanism 89 is operated to move the left rail 72. Referring to the movement of rails, either the right rail 71 or the left rail 72 may be moved. Alternatively, a mechanism may be provided such that when one of the two rails is moved, the other is synchronously moved. Alternatively, the right rail 71 and the left rail 72 may be provided with the respective shift mechanism which operates independently of the other so that they are moved independently of each other.

The film 28 which has been conveyed to the tenter chamber 50 then enters the tenter device 51 through the inlet 76 thereof. The film 28 is then conveyed through the interior of the tenter device 51 while being gripped by the film clip 80 at the both edges thereof. The film 28 is heated to a desired temperature in the preheating portion 51a. Thereafter, the film clips 80 are moved outward toward downstream while being guided by the right rail 71 and the left rail 72, respectively, to stretch the film 28 in the crosswise direction Y in the stretching portion 51b. During this procedure, the strain of the film 28 is measured by the strain indicator 87. The measurements are then transmitted to the controller 88. The controller 88 then calculates the stress developed on the film 28 (hereinafter referred to as “crosswise stress”) Sy (Pa) from the measurements. In order to prevent the film 28 from having optical anisotropy due to orientation of polymer in the film, the ratio (Sy/Sx) of crosswise stress Sy to stress Sx in the conveying direction is predetermined to be from 2 to 50, preferably from 5 to 30. The draw ratio, stretching rate and temperature of the film are not specifically limited. The transparent support of the invention is characterized in that the stress ratio falls within the above defined range.

In the invention, the maximum stress in the crosswise direction Y (hereinafter referred to as “maximum crosswise stress”) Syₘₐₓ (Pa) is predetermined to be from 1 MPa to 200 MPa, preferably 5 MPa to 80 MPa. This, too, is a characteristic of the transparent support of the invention. When the maximum crosswise stress Syₘₐₓ falls below 1 MPa, the force for stretching the film 28 is insufficient, making it impossible to make desired stretching. On the contrary, when the maximum crosswise stress Syₘₐₓ exceeds 200 MPa, the orientation of polymer molecules in the film 28 changes, causing the development of optical anisotropy in the film 28 and hence the deterioration of optical properties thereof. When the maximum crosswise stress Syₘₐₓ is from 1 MPa to 200 MPa, the draw ratio, stretching rate and surface temperature of the film 28 and the atmosphere temperature of the tenter chamber 50 are not specifically limited but may be properly predetermined. By predetermining the stress ratio (Sy/Sx) to fall within the range of from 2 to 50, preferably from 5 to 30, the development of optical anisotropy in the film can be prevented. In the invention, the stress (Pa) is defined to be a value (N/m²=Pa) obtained by dividing the force (N) applied to the film 28 by the sectional area (m²) of the film 28. The maximum crosswise stress Syₘₐₓ (Pa) is defined to be the maximum value in the crosswise direction Sy developed during stretching which varies with time.

The controller 88 calculates the optimum draw ratio from the measurements given by the various strain indicators 87.

The controller 88 calculates the shift of the shift mechanism 89 from the measurements to cause the shift mechanism 89 to move, making it possible to predetermine the maximum crosswise stress Syₘₐₓ to fall within the range of from 1 MPa to 200 MPa. The measurements of stress Sx in the conveying direction given by the tension meter 29 are preferably transmitted to the controller 88. In this manner, the shift such that the stress (Sy/Sx) falls within the range of 2 to 50 can be determined, making it possible to shift the shift mechanism 89 properly.

The film 28 is preferably stretched while the content of residual solvent falls within the range of from 3% by weight to 45% by weight, more preferably 7% by weight to 35% by weight. When the content of residual solvent falls within the above defined range, the drying of the film 28 proceeds sufficiently. Further, the plasticity of the film 28 can be retained, making it possible to stretch the film 28 smoothly without any damage. Moreover, the film 28 can be easily gripped by the film clip 80, making it possible to prevent the occurrence of conveying troubles such as film break during conveyance. In the invention, the content of residual solvent is represented by the following equation (1).

Content of residual solvent (wt-%)=((A−B)/A×100 (1)

wherein A represents the weight of the sample film; and B represents the weight of the sample film A which has been air-dried at 110° C. for 1 hour

The measurement of the weight of the sample film can be carried out by any known method. For example, a method may be employed which comprises cutting the film 28 into a size of 10 mm×40 mm, measuring the weight of the sample, and then air-dry the sample.

The film 28 thus stretched is preferably subjected to heat treatment in the heat treatment portion 51c to accelerate stress relaxation. The heat treatment is preferably effected at a temperature of from 50° C. to 180° C., more preferably from 80° C. to 130° C. The heat treatment time is preferably from 1 second to 30 seconds, more preferably from 3 seconds to 15 seconds. When the heat treatment temperature is from 50° C. to 180° C., the shrinkage of the film 28 due to sudden temperature drop can be prevented. Further, the deformation of the film 28 due to plasticity can be prevented. When the heat treatment time is from not smaller than 1 second to not greater than 30 seconds, the relaxation of stress of the film can be sufficiently effected, making it possible to prevent the film 28 from undergoing deformation due to stress drop at the subsequent step. Further, the film 28 can be properly dried, causing little decomposition of solutes such as polymer and additives in the film 28.

The tenter device to be used in the invention is not limited to the embodiment shown in FIG. 4.

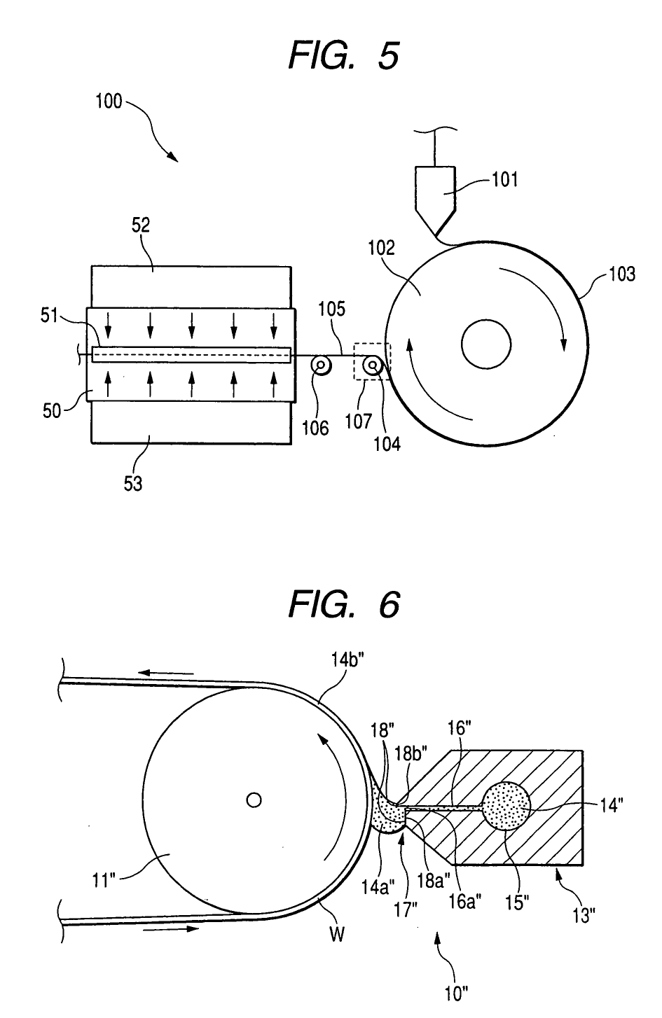

While as the support in the film making line 10 of FIG. 3 there is used the casting band 23, the support of the invention is not limited thereto. In the film making line 100 (FIG. 5), which indicates a part of the film making line 10, a rotary drum 102 is disposed downstream from the casting die 101. The dope is casted from the casting die 101 over the rotary drum 102 to form a cast film 103. When the cast film 103 has become self-supporting, it is then peeled off the rotary drum 102 as a film 105 while being supported on a peeling roller 104. The film 105 thus peeled is then conveyed to the tenter chamber 50 by the roller 106 provided in the transfer portion. In this case, too, the stress Sx (Pa) in the conveying direction can be adjusted by adjusting the rotary speed of the rotary drum 102 and the roller 104. For the measurement of the stress Sx in the conveying direction, a tension meter 107 is used. For the drying and stretching in the tenter chamber 50, the same methods as described above may be used.

While only single-layer casting is shown in the drawings, the method of film making of transparent support coating solution of the invention can be applied also to multi-layer casting. Examples of multi-layer casting method include co-casting method involving the use of multi-manifold casting dye or feed block provided upstream from the casting die, successive casting method involving the use of a plurality of casting dies provided on casting band, and successive co-casting method involving the two casting methods in combination.

The aforementioned hard coat layer will be described hereinafter.

### (Hard Coat Layer)

The hard coat layer is formed for the purpose of making up for the insufficiency of indentation elasticity of the transparent support made of plastic film and providing the film with scratch resistance evaluated as pencil scratch or the like.

The hard coat layer of the invention comprises an ionized radiation-curing resin as a main component. The thickness of the hard coat layer is preferably from 3 to 15 μm. When the thickness of the hard coat layer is from 3 to 15 μm, the resulting effect of improving indentation elasticity makes it possible to reduce the number of point defects on the surface of the hard coat layer due to foreign matters having a particle diameter of few micrometers. Further, since the anti-reflection film which has a hard coat film or anti-reflection layer formed thereon undergoes less curling, the anti-reflection film exhibits an improved handleability and even enhanced flexibility and lower brittleness and hence improved workability at the subsequent step.

From the standpoint of yield in the application to polarizing plate and liquid crystal display, the number of point defects having a size of 50 μm or more per m² on the surface of the hard coat layer is preferably 5 or less.

### <Light-Transmitting Resin>

The light-transmitting resin to be incorporated in the hard coat layer is preferably a binder polymer having a saturated hydrocarbon chain or polyether chain as a main chain, more preferably a binder polymer having a saturated hydrocarbon chain as a main chain. The binder polymer preferably has a crosslinked structure.

The binder polymer having a saturated hydrocarbon chain as a main chain is preferably a polymer of ethylenically unsaturated monomers. The binder polymer having a saturated hydrocarbon chain as a main chain and a crosslinked structure is preferably a (co)polymer of monomers having two or more ethylenically unsaturated groups.

Examples of the monomer having two or more ethylenically unsaturated groups which is used as a main component include esters of polyvalent alcohol with (meth)acrylic acid (e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipenta erythritol tetra(meth)acrylate, dipentaerythritol penta(meth)acrylate, dipentaerythritol hexa(meth)acrylate, pentaerythritol hexa(meth)acrylate, 1,2,3-cyclohexatetramethacrylate, polyurethane polyacrylate, polyester polyacrylate), ethylene oxide modification products, propylene oxide modification products and caprolactone modification products of the aforementioned esters, vinylbenzene and derivatives thereof (e.g., 1,4-divinylbenzene, 4-vinylbenzoic acid-2-acryloylethylester, 1,4-divinylcyclohexanone), vinylsulfones (e.g., divinylsulfone), acylamides (e.g., methylene bisacrylamide), and methacrylamides.

### <Photopolymerization Initiator>

The polymerization of these light-transmitting resins is initiated by irradiating the following photoradical polymerization initiator with ionized radiation. Examples of the photoradical polymerization initiator include acetophenones, benzoins, benzophenones, phosphine oxides, ketals, anthraquinones, thioxanetones, azo compounds, peroxides, 2,3-dialkyldione compounds, disulfide compounds, fluoroamine compounds, and aromatic sulfoniums. Examples of the acetophenones include 2,2-diethoxyacetophenone, p-dimethylacetophenone, 1-hydroxydimethylphenylketone, 1-hydroxycyclohexyl phenyl ketone, 2-methyl-4-methylthio-2-morpholino propiophenone, and 2-benzyl-2-dimethylamino-1-(4-morpholinophenyl)-butanone. Examples of the benzoins include benzoinbenzenesulfonic acid ester, benzoin toluenesulfonic acid ester, benzoin methyl ether, benzomethyl ether, and benzoin isopropyl ether. Examples of the benzophones include benzophenone, 2,4-diclilorobenzophenone, 4,4-dichlorobenzophenone, and p-chlorobenzophenone. Examples of the phosphine oxides include 2,4,6-trimethylbenzoyl diphenyl phosphine oxide.

Various examples are disclosed in Kazuhiro Takahashi, “Saishin UV Koka Gijutsu (Newest UV Curing Technique)”, TECHNICAL INFORMATION INSTITUTE CO., LTD., page 159, 1991. These examples are useful in the invention.

Preferred examples of commercially available photocleavable photoradical polymerization initiators include Irgacure (651, 184, 907) (produced by Nihon Ciba-Geigy K.K.).

The photopolymerization initiator is preferably used in an amount of from 0.1 to 15 parts by weight, more preferably from 1 to 10 parts by weight based on 100 parts by weight of polyfunctional monomer.

In addition to the photopolymerization initiator, a photosensitizer may be used. Specific examples of the photosensitizer include n-butylamine, triethylamine, tri-n-butylphosphine, Michler's ketone, and thioxanthone.

In addition to the incorporation of the light-transmitting resin, a monomer having a crosslinkable functional group may be used to incorporate a crosslinkable functional group in the polymer whereby the reaction of the crosslinkable functional group causes the incorporation of a crosslinked structure in the binder polymer.

Examples of the crosslinkable functional group include isocyanate groups, epoxy groups, aziridine groups, oxazoline groups, aldehyde groups, carbonyl groups, hydrazine groups, carboxyl groups, methylol groups, and active methylene groups. A vinylsulfonic acid, an acid anhydride, a cyano acrylate derivative, a melamine, an etherified methylol, an ester, an urethane or a metal alkoxide such as tetramethoxysilane may be used as a monomer for the incorporation of a crosslinked structure. A functional group which exhibits crosslinkability as a result of decomposition reaction such as blocked isocyanate group may be used. In other words, the crosslinkable functional group to be used in the invention may be not immediately reactive but may be reactive as a result of decomposition reaction.

These binder polymers having a crosslinkable functional group may form a crosslinked structure when heated after being spread.

### <Particulate Light-Transmitting Material>

The particulate light-transmitting material to be incorporated in the hard coat layer for the purpose of providing the hard coat layer with light scattering properties is intended to provide light diffusivity and anti-glare properties. The average particle diameter of the particulate light-transmitting material is from 0.5 μm to 5 μm, preferably from 1.0 μm to 4.0 μm. When the average particle diameter of the particulate light-transmitting material falls below 0.5 μm, the distribution of light scattering angle extends widely, causing the deterioration of letter resolution of display or making it difficult to form surface roughness and hence causing the shortage of anti-glare properties to disadvantage. On the contrary, when the average particle diameter of the particulate light-transmitting material exceeds 5 μm, it becomes necessary that the thickness of the hard coat layer be raised, causing troubles such as increased curling and raised material cost.

Specific examples of the aforementioned particulate light-transmitting material include particulate materials of inorganic compounds such as TiO₂ and resins such as acrylic resin, crosslinked acrylic resin, methacrylic resin, crosslinked methacrylic resin, polystyrene resin, crosslinked styrene resin, melamine resin and benzoguanamine resin. Preferred among these particulate light-transmitting materials are particulate crosslinked styrene resin, particulate acrylic resin, particulate acrylstyrene resin and particulate silica.

The particulate light-transmitting material may be spherical or amorphous.

Two or more particulate light-transmitting materials having different particle diameters may be used in combination. The incorporation of a particulate light-transmitting material having a larger particle diameter makes it possible to provide anti-glare properties while the incorporation of a particulate light-transmitting material having a smaller particle diameter makes it possible to provide other optical properties. For example, in the case where an anti-reflection film is stuck to a high precision display having 133 ppi or more, it is required that no such optical defects as glare as mentioned above occur. Glare is attributed to the loss of uniformity of brightness caused by the expansion or shrinkage of pixels due to unevenness present on the surface of the film (contributing to anti-glare properties). The additional use of a particulate light-transmitting material having a smaller particle diameter than the particulate light-transmitting material providing anti-glare properties and a refractive index different from that of the binder makes it possible to drastically eliminate glare.

The particle diameter distribution of the aforementioned particulate light-transmitting material is most preferably monodisperse. The particle diameter of the various particles are preferably as close to each other as possible. For example, in the case where particles having a particle diameter which is 20% or more greater than the average particle diameter are defined to be coarse particles, the proportion of these coarse particles is preferably 1% or less, more preferably 0.1% or less, even more preferably 0.01% or less of the total number of particles. A particulate light-transmitting material having such a particle diameter distribution can be obtained by classification after normal synthesis. By increasing the number of times of classification or strengthening the degree of classification, a preferred distribution can be obtained.

The aforementioned particulate light-transmitting material is incorporated in the hard coat layer thus formed in an amount of from 3 to 30%, preferably from 5 to 20% by weight based on the total solid content in the hard coat layer. When the content of the particulate light-transmitting material falls below 3% by weight, the light scattering effect is insufficient. On the contrary, when the content of the particulate light-transmitting material exceeds 30% by weight, there occur defectives such as drop of image resolution and clouding and glare of surface.

The density of the particulate light-transmitting material is preferably from 10 to 1,000 mg/m², more preferably from 100 to 700 mg/m².

The particle diameter distribution of the particulate light-transmitting material is measured by a coulter counter method. The distribution thus measured is then converted to value as calculated in terms of number of particles.

The hard coat layer preferably comprises an inorganic filler having an average particle diameter of 0.2 μm or less, preferably 0.1 μm or less, more preferably 0.06 μm or less made of an oxide of at least one metal selected from the group consisting of titanium, zirconium, aluminum, indium, zinc, tin and antimony incorporated therein in addition to the aforementioned particulate light-transmitting material to raise the refractive index thereof.

On the contrary, in order to raise the difference in refractive index from that of the particulate light-transmitting material, the hard coat layer comprising a high refractive particulate light-transmitting material incorporated therein preferably also comprises a silicon oxide incorporated therein to keep the refractive index thereof low. The preferred particle diameter of the particulate silicon oxide is the same as that of the aforementioned inorganic filler.

Specific examples of the inorganic filler to be incorporated in the hard coat layer include TiO₂, ZrO₂, Al₂O₃, In₂O₃, ZnO, SnO₂, Sb₂O₃, ITO, and SiO₂. Particularly preferred among these inorganic fillers are TiO₂ and ZrO₂ from the standpoint of capability of raising refractive index. The inorganic filler is preferably subjected to silane coupling or titanium coupling treatment on the surface thereof. A surface treatment agent having a reactive group that can react with the binder seed on the surface of the filler is preferably used.

The added amount of these inorganic fillers, if any, is preferably from 10 to 90%, more preferably from 20 to 80%, particularly from 30 to 75% based on the total weight of the hard coat layer.

These inorganic fillers have a particle diameter that is sufficiently smaller than the wavelength of light and thus cause no scattering of light. Therefore, the dispersion having these fillers dispersed in a binder polymer behaves as an optically uniform material.

The hard coat layer, too, may comprise the organosilane compound described later incorporated therein.

The amount of the organosilane compound to be incorporated in the hard coat layer is preferably from 0.001 to 50% by weight, more preferably from 0.01 to 20% by weight, even more preferably from 0.05 to 10% by weight, particularly from 0.1 to 5% by weight based on the total solid content in the hard coat layer.

The refractive index of the bulk of a mixture of light-transmitting resin and particulate light-transmitting material of the invention is preferably from 1.48 to 2.00, more preferably from 1.50 to 1.80. In order to predetermine the refractive index of the bulk within the above defined range, the kind and proportion of the light-transmitting resin and the particulate light-transmitting material may be properly selected. The method of selecting these factors can easily be previously known experimentally.

In the invention, the difference in refractive index between the light-transmitting resin and the particulate light-transmitting material (refractive index of particulate light-transmitting material—refractive index of light-transmitting resin) is from 0.02 to 0.2, preferably from 0.05 to 0.15. When the difference falls below 0.02, the internal scattering effect is insufficient, worsening glare. When the difference exceeds 0.2, the surface of the film becomes cloudy.

The refractive index of the aforementioned light-transmitting resin is preferably from 1.45 to 2.00, more preferably from 1.48 to 1.60.

The refractive index of the aforementioned particulate light-transmitting material is preferably from 1.40 to 1.80, more preferably from 1.50 to 1.70.

The refractive index of the aforementioned light-transmitting resin can be directly measured or quantitatively evaluated by measuring spectral reflection spectrum or spectral ellipsometry.

### <Surface Active Agent>

The hard coat layer-forming coating composition of the invention may comprise either or both of a fluorine-based surface active agent and a silicone-based surface active agent incorporated therein to assure uniformity in surface conditions such as coating uniformity, drying uniformity and point defect. In particular, a fluorine-based surface active agent is preferably used because it can exert an effect of eliminating defects in surface conditions such as coating unevenness, drying unevenness and point defect.

The surface active agent is intended to render the hard coat layer-forming coating composition adaptable to high speed coating while enhancing the uniformity in surface conditions so as to enhance the productivity.

Preferred examples of the fluorine-based surface active agent include fluoroaliphatic group-containing copolymers (hereinafter occasionally abbreviated as “fluorine-based polymer”). Useful examples of the fluorine-based polymer include acrylic resins and methacrylic resins containing repeating units corresponding to the following monomer (i) and repeating units corresponding to the following monomer (ii), and copolymers of these monomers with vinyl-based monomers copolymerizable therewith.

(i) Fluoroaliphatic group-containing monomer represented by the following formula (FF):

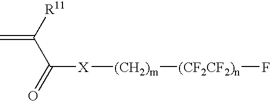

wherein R¹¹ represents a hydrogen atom or methyl group; X represents an oxygen atom, sulfur atom or —N(R¹²)— in which R¹² represents a hydrogen atom or a C₁-C₄alkyl group such as methyl, ethyl, propyl and butyl, preferably hydrogen atom or methyl; m represents an integer of from 1 to 6; and n represents an integer of from 1 to 3. X is preferably an oxygen atom.

In the formula (FF), m represents an integer of from 1 to 6, particularly 2.

In the formula (FF), n represents an integer of from 1 to 3. A mixture of fluoroaliphatic group-containing monomers represented by the following formula (FF) wherein n is from 1 to 3 may be used.

(ii) Monomer represented by the following formula (FA) copolymerizable with the monomer (i)

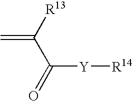

wherein R¹³ represents a hydrogen atom or methyl group; and Y represents an oxygen atom, sulfur atom or —N(R¹⁵)— in which R¹⁵ represents a hydrogen atom or a C₁-C₄ alkyl group such as methyl, ethyl, propyl and butyl, preferably hydrogen atom or methyl. Y is preferably an oxygen atom, —N(H)— or —N(CH₃)—.

R¹⁴ represents a C₄-C₂₀ straight-chain, branched or cyclic alkyl group which may have substituents. Examples of the substituents on the alkyl group represented by R¹⁴ include hydroxyl groups, alkylcarbonyl groups, arylcarbonyl groups, carboxyl groups, alkylether groups, arylether groups, halogen atoms such as fluorine atom, chlorine atom and bromine atom, nitro group, cyano group, and amino group. The invention is not limited to these substituents. As the C₄-C₂₀ straight-chain, branched or cyclic alkyl group there may be used butyl, pentyl, hexyl, heptyl, octyl, nonyl, decyl, undecyl, dodecyl, tridecyl, tetradecyl, pentadecyl, octadecyl or eicosanyl group which may be straight-chain or branched, a monocyclic cycloalkyl or bicycloheptyl group such as cyclohexyl and cycloheptyl or polycyclic cycloalkyl group such as bicycloheptyl, bicyclodecyl, tricycloundecyl, tetracyclododecyl, adamanthyl, norbonyl and tetracyclodecyl.

The proportion of the fluoroaliphatic group-containing monomer represented by the formula (FF) in the total amount of monomers used for the formation of fluorine-based polymer containing as polymerizing units fluoroaliphatic group-containing monomers represented by the formula (FF) is 10 mol-% or more, preferably from 15 to 70 mol-%, more preferably from 20 to 60 mol-%.

The weight-average molecular weight of the fluorine-based polymer containing as polymerizing units fluoroaliphatic group-containing monomers represented by the formula (FF) is preferably from 3,000 to 100,000, more preferably from 5,000 to 80,000. The weight-average molecular weight indicates molecular weight in polystyrene equivalence detected by a differential refractometer using a GPC analyzer comprising TSKgel GMH_{X}L, TSKgel G4000H_{X}L or TSKgel G2000H_{X}L (produced by TOSOH CORPORATION) as a column with THF as a solvent. The content of the fluorine-based polymer indicates the percent area of the peak having a molecular weight falling within the above cited range wherein the percent area of the peak having a molecular weight of 300 or more is 100%.

The added amount of the fluorine-based polymer comprising fluoroaliphatic group-containing monomers represent by the formula (FF) is preferably from 0.001 to 5% by weight, more preferably from 0.005 to 3% by weight, even more preferably from 0.01 to 1% by weight based on the weight of the coating solution from the standpoint of development of effect, coating of coat layer and properties of coat layer (e.g., reflectance, scratch resistance).

Specific examples of the structure of fluorine-based polymer comprising fluoroaliphatic group-containing monomers represented by the formula (FF) will be given below, but the invention is not limited thereto. The figure in the following formulae indicates the molar fraction of the various monomer polymerizing components. Mw indicates the weight-average molecular weight.

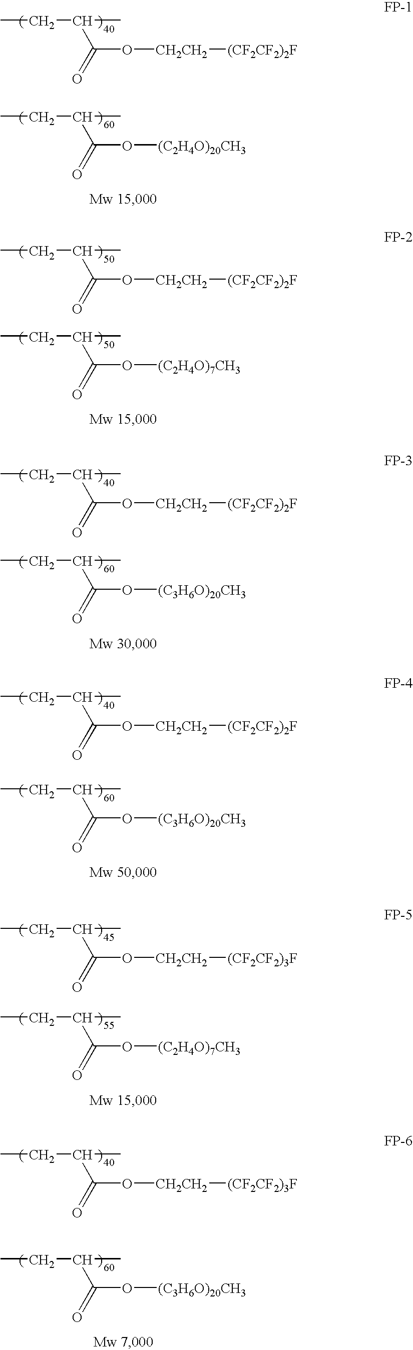

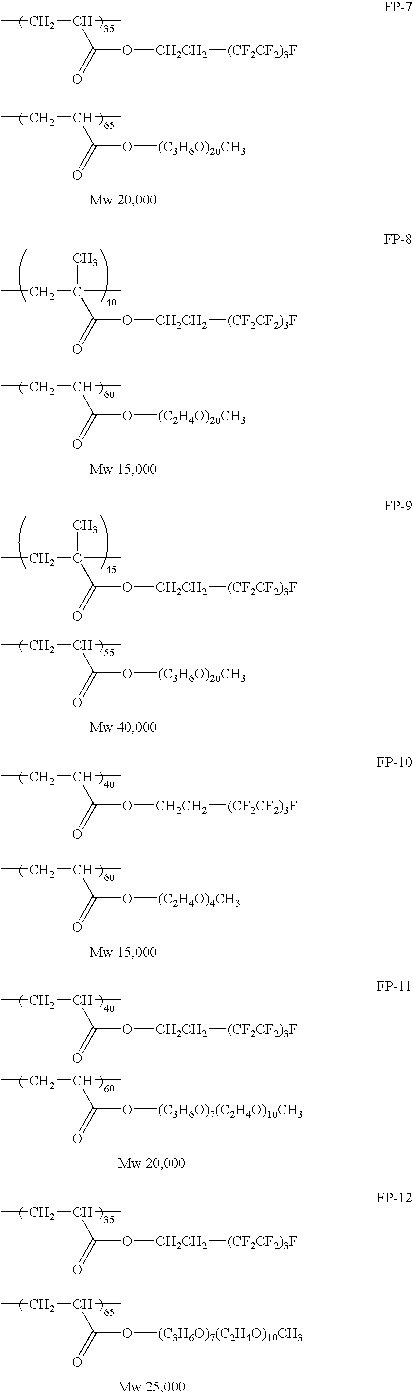

Alternatively, as the upper layer-forming composition there can be selected a fluorine-based polymer which can be extracted with the solvent for use in the formation of the upper layer. In this manner, the upper layer-forming composition can be prevented from being unevenly distributed on the surface (=interface) of the lower layer, causing the upper layer and the lower layer adhesive to each other. Therefore, the surface conditions can be kept uniform even when coating is effected at a high speed. Further, an anti-reflection film having a high scratch resistance can be provided. An example of such a material is a fluorine-based polymer comprising monomers represented by the following formula (FH):

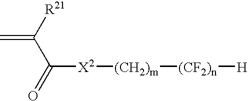

wherein R²¹ represents a hydrogen atom, halogen atom or methyl group, preferably hydrogen atom or methyl group; X² represents an oxygen atom, sulfur atom or —N(R²²)— (in which R²² represents a hydrogen atom or C₁-C₈ alkyl group which may have substituents, preferably hydrogen atom or C₁-C₄ alkyl group, more preferably hydrogen atom or methyl group), preferably oxygen atom or —N(R²²)—, particularly oxygen atom; m represents an integer of from 1 to 6; and n represents an integer of from 1 to 18. X² is preferably an oxygen atom.

The fluorine-based polymer may comprise as constituents two or more fluoroaliphatic group-containing monomers represented by the following formula (FB).

(iv) Monomer represented by the following formula (FB) copolymerizable with the monomer (iii).

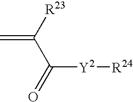

wherein R²³ represents a hydrogen atom, halogen atom or methyl group, preferably hydrogen atom or methyl group; Y² represents an oxygen atom, sulfur atom or —N(R²⁵)—, preferably oxygen atom or —N(R²⁵)—, more preferably oxygen atom; and R²⁴ represents a hydrogen atom or C₁-C₈ alkyl group, preferably hydrogen atom or C₁-C₄ alkyl group, hydrogen atom or methyl group.

R²⁵ represents a C₁-C₂₀ straight-chain, branched or cyclic alkyl group which may have substituents, an alkyl group containing a poly(alkyleneoxy) group or an aromatic group which may have substituents (e.g., phenyl, naphthyl), preferably C₁-C₁₂ straight-chain, branched or cyclic alkyl group, more preferably an aromatic group having from 6 to 18 carbon atoms in total, even more preferably C₁-C₈ straight-chain, branched or cyclic alkyl group.

In the fluororesin-based polymer comprising as polymerizing units fluoroaliphatic group-containing monomers represented by the formula (FH), the proportion of the fluoroaliphatic group-containing monomers represented by the formula FH in the total amount of monomers for use in the formation of the fluorine-based polymer is preferably 50 mol-% or more, more preferably from 70 to 100 mol-%, particularly from 80 to 100 mol-%.

The weight-average molecular weight of the fluorine-based polymer comprising as polymerizing units fluoroaliphatic group-containing monomers represented by the formula (FH) is preferably from 3,000 to 100,000, more preferably from 6,000 to 80,000, even more preferably from 8,000 to 60,000.

The added amount of the fluorine-based polymer comprising fluoroaliphatic group-containing monomers represented by the formula (FH) is preferably from 0.001 to 5% by weight, more preferably from 0.005 to 3% by weight, even more preferably from 0.01 to 1% by weight based on the weight of the coating solution of the layer in which the fluorine-based polymer is incorporated.

Specific examples of the structure of the fluorine-based polymer comprising fluoroaliphatic group-containing monomers represented by the formula (FH) will be given below, but the invention is not limited thereto. The figure in the following formulae indicates the molar fraction of the various monomer polymerizing components. Mw indicates the weight-average molecular weight.

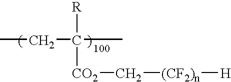

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

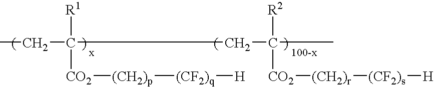

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

### <Solvent>

Since the hard coat layer-forming coating solution of the invention may be wet-spread directly over the transparent support, the selection of the solvent to be used in the coating composition is particularly important. The solvent is required to dissolve the various solutes sufficiently therein, cause no coating unevenness and drying unevenness during the coating and drying steps, cause no dissolution of the support (necessary for prevention of defectives such as deterioration of flatness and whitening) and cause some swelling of the support (necessary for adhesion).

In some detail, in the case where the support is made of a triacetyl cellulose, various ketones (e.g., methyl ethyl ketone, acetone, methyl isobutyl ketone, cyclohexanone) and various cellosolves (e.g., ethyl cellosolve, butyl cellosolve, propylene glycol monomethyl ether) may be used in proper admixture. In order to adjust swelling properties, solvents having a high dissolving power such as methyl acetate and ethyl acetate and solvents in which the support can difficultly swell such as toluene, methanol, ethanol, propanol, isopropanol, butanol, 2-butanol and tert-butanol may be used in proper admixture. In particular, in the case where a hard coat layer which has comprised a particulate light-transmitting material incorporated therein to have anti-glare properties is formed directly on the triacetyl cellulose, it is preferred that a solvent having a low dissolving power such as methyl isobutyl ketone and toluene be mainly used and cyclohexanone, methyl ethyl ketone or the like be used as a subsidiary component.

The aforementioned low refractive index layer will be further described hereinafter.

### (Low Refractive Index Layer)

The refractive index of the low refractive index layer in the anti-reflection film of the invention is preferably from 1.30 to 1.55, more preferably from 1.35 to 1.45 from the standpoint of balance of anti-reflection properties and film strength.

The low refractive index layer preferably satisfies the following numerical relationship (I) from the standpoint of reduction of reflectance.

(m/4)×0.7<nd×dl<(m/4)×1.3 (I)

wherein m represents a positive odd number; n1 represents the refractive index of the low refractive index layer; and d1 represents the thickness (nm) of the low refractive index layer. λ indicates wavelength falling within a range of from 500 to 550 nm.

The satisfaction of the aforementioned numerical relationship (I) means that there is m (positive odd number, normally 1) satisfying the numerical relationship (I) in the above defined range of wavelength.

The material constituting the low refractive index layer will be further described hereinafter.

The low refractive index layer in the anti-reflection film of the invention comprises a binder component, a small amount of additives, and a solvent. The binder component is preferably one having a low refractive index such as fluoropolymer and particulate inorganic material described later. In order to enhance the cohesive force of the layer, the low refractive index layer may comprise any of an organosilane compound and hydrolyzate and condensate thereof (sol component), a curable compound or the like incorporated therein as a part of binder component. Alternatively, a sol component may be used as a main component to form a sol-gel layer. The binder component, if used as a sol-gel layer, preferably has a partly or fully fluorine-substituted alkyl group. Examples of the additives to be used in a small amount include stain proofing agents, lubricants, dustproofing agents, antistatic agents, and polymerization initiators.

<fluorine-Containing Polymer>

In a preferred embodiment of the low refractive index layer of the invention, as the low refractive binder there is incorporated a fluorine-containing polymer. The fluorine-containing polymer is preferably one having a dynamic friction coefficient of from 0.03 to 0.20, a contact angle of from 90° to 1200 with respect to water and a pure water slipping angle of 70° or less which undergoes crosslinking when heated or irradiated with ionized radiation. In order to reduce the refractive index of the low refractive index layer and provide the low refractive index layer with cohesive force and adhesion to the underlying layer, the fluorine-containing polymer preferably contains fluorine atoms in an amount of from 35 to 80% by weight. In the case where the anti-reflection film of the invention is mounted on an image display, the lower the peeling force of the low refractive index layer is, the more can be easily peeled a seal or adhesive memo pad off the low refractive index layer. The peeling force of the low refractive index layer with respect to these materials is preferably 500 gf or less, more preferably 300 gf or less, most preferably 100 gf or less. The higher the surface hardness of the low refractive index layer as measured by a microhardness tester is, the more difficulty can be scratched the low refractive index layer. The surface hardness of the low refractive index layer is preferably 0.3 GPa or more, more preferably 0.5 GPa or more.

Examples of the fluorine-containing polymer to be used in the low refractive index layer include hydrolyzates and dehydration condensates of fluoroalkyl group-containing silane compounds (e.g., (heptadecafluoro-1,1,2,2-tetrahydrodecyl)triethoxysilane), and fluorine-containing copolymers comprising a fluorine-containing monomer unit and a constituent unit for providing crosslinking reactivity.

The former fluorine-containing polymer is preferably one formed by the sol-gel reaction of a compound represented by the following formula (2).

(R²)ₙSi(Y)₄₋ₙ (2)

wherein R² represents a substituted or unsubstituted alkyl group, partly or fully fluorine-substituted alkyl group or substituted or unsubstituted aryl group; Y represents a hydroxyl group or hydrolyzable group; and n represents an integer of from 0 to 3. In order that the polymer formed by the sol-gel reaction of a compound represented by the formula (2) might be a fluorine-containing polymer, it is necessary that at least one compound represented by the formula (2) wherein R² is a partly or fully fluorine-substituted alkyl group be used. In some detail, R² represents a C₁-C₃₀ alkyl group, C₁-C₃₀ partly or fully fluorine-substituted alkyl group or C₆-C₃₀ substituted or unsubstituted aryl group. The partly fluorine-substituted alkyl group, if any, may have substituents other than fluorine atom. Examples of the substituents on these groups include those listed as substituents with reference to the group represented by R¹⁰ in the formula (1) described later. Examples of the hydrolyzable group represented by Y include halogen atoms (e.g., chlorine, bromine), C₁-C₅alkoxy groups (e.g., methoxy, ethoxy, propoxy, butoxy), and C₁-C₅ acyloxy groups (e.g., acetoxy, propanoyloxy). Particularly preferred among these hydrolyzable groups are methoxy group and ethoxy group. R² is preferably a partly or fully fluorine-substituted alkyl group. Specific examples of the compound represented by the formula (2) include CF₃(CH₂)₂Si(OCH₃)₃, CF₃CF₂ (CH₂)₂Si(OCH₃)₃, CF₃(CH₂)₂(CH₂)₂Si(OCH₃)₃, CF₃(CF₂)₃ (CH₂)₂Si(OCH₃)₃, CF₃(CF₂)₄(CH₂)₂Si(OCH₃)₃, CF₃(CF₂)₅ (CH₂)₂Si(OCH₃)₃, CF₃(CF₂)₆(CH₂)₂Si(OCH₃)₃, CF₃(CF₂)₇ (CH₂)₂Si(OCH₃)₃, CF₃(CF₂)₈(CH₂)₂Si(OCH₃)₃, CF₃(CF₂)₉ (CH₂)₂Si(OCH₃)₃, CF₃(CH₂)₂Si(OC₂H₅)₃, CF₃CF₂(CH₂)₂Si (OC₂H₅)₃, CF₃(CF₂)₂(CH₂)₂Si(OC₂H₅)₃, CF₃(CF₂)₃(CH₂)₂ Si(OC₂H₅)₃, CF₃(CF₂)₄(CH₂)₂Si(OC₂H₅)₃, CF₃(CF₂)₅(CH₂)₂Si(OC₂H₅)₃, CF₃(CF₂)₆(CH₂)₂Si(OC₂H₅)₃, CF₃(CF₂)₇ (CF₂)₇(CH₂)₂Si(OC₂H₅)₃, CF₃(CF₂)₈(CH₂)₂Si(OC₂H₅)₃, and CF₃(CF₂)₉(CF₂)₉(CH₂)₂Si (OC₂H₅)₃. Particularly preferred among these compounds are CF₃(CF₂)₇(H₂)₂Si(OCH₃)₃ and CF₃(CF₂)₇(CF₂)₇(CH₂)₂Si(OC₂H₅)₃. For the hydrolyzation or dehydration condensation of these compounds, a method described with reference to the compounds represented by the formulae (1) and (3) may be used.

Specific examples of the fluorine-containing monomer constituting the fluorine-containing copolymer comprising a fluorine-containing monomer unit and a constituent unit for providing crosslinking reactivity as constituent components include fluoroolefins (e.g., fluoroethylene, vinylidene fluoride, tetrafluoro ethylene, perfluorooctylethylene, hexafluoropropylene, perfluoro-2,2-dimethyl-1,3-dioxonol), partly or fully-fluorinated alkylester derivatives of (meth)acrylic acid (e.g., Biscoat 6FM (produced by OSAKA ORGANIC CHEMICAL INDUSTRY LTD, M-2020 (produced by DAIKIN INDUSTRIES, Ltd.)), and fully or partly-fluorinated vinyl ethers. Preferred among these fluorine-containing monomers are perfluoroolefins. Particularly preferred among these fluorine-containing monomers is hexafluoropropylene from the standpoint of refractive index, solubility, transparency, availability, etc.

Examples of the constituent unit for providing crosslinking reactivity include constituent units obtained by the polymerization of monomers previously having a self-crosslinkable functional group in molecule such as glycidyl(meth)acrylate and glycidyl vinyl ether, constituent units obtained by the polymerization of monomers having carboxyl group, hydroxyl group, amino group, sulfo group, etc. (e.g., (meth)acrylic acid, methylol (meth)acrylate, hydroxyalkyl(meth)acrylate, allyl acrylate, hydroxyethyl vinyl ether, hydroxybutyl vinyl ether, maleic acid, crotonic acid), and constituent units obtained by introducing a crosslinkable functional group such as (meth)acryloyl group into these constituent units by a polymer reaction (e.g., method involving the reaction of hydroxyl group with acrylic acid chloride).

Besides the aforementioned fluorine-containing monomer units and constituent units for providing crosslinking reactivity, fluorine-free monomers may be properly copolymerized from the standpoint of solubility in solvent, transparency of film, etc. The monomers to be used in combination with the aforementioned constituent units are not specifically limited. Examples of these monomers include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (methyl methacrylate, ethyl methacrylate, butyl methacrylate, ethylene glycol dimethacrylate), styrene derivatives (e.g., styrene, divinyl benzene, vinyl toluene, α-methylstyrene), vinyl ethers (e.g., methyl vinyl ether, ethyl vinyl ether, cyclohexyl vinyl ether), vinyl esters (e.g., vinyl acetate, vinyl priopionate, vinyl cinnamate), acrylamides (e.g., N-tert butylacrylamide, N-cyclohexyl acrylamide), methacrylamides, and acrylonitrile derivatives.

The aforementioned polymers may be used properly in combination with a curing agent as disclosed in JP-A-10-25388 and JP-A-10-147739.

The fluorine-containing polymer which is particularly preferred in the invention is a random copolymer of perfluoroolefin with vinyl ether or vinyl ester. It is particularly preferred that the fluorine-containing polymer have a group which can undergo crosslinking reaction by itself (e.g., radical-reactive group such as (meth)acryloyl group, ring-opening polymerizable group such as epoxy group and oxetanyl group). These crosslinkable functional group-containing polymerizing units preferably account for from 5 to 70 mol-%, particularly from 30 to 60 mol-% of the total polymerizing units of the polymer.

A preferred embodiment of the copolymer to be used in the invention is one represented by the following formula (1).

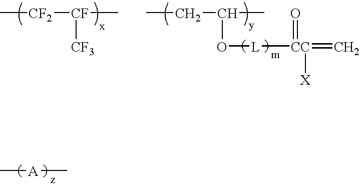

In the formula (1), L represents a C₁-C₁₀ connecting group, preferably a C₁-C₆ connecting group, particularly C₂-C₄ connecting group. The connecting group may be straight-chain or may have a branched or cyclic structure. The connecting group may have hetero atoms selected from the group consisting of oxygen, nitrogen and sulfur.

Preferred examples of L include *—(CH₂)₂—O—**, *—(CH₂)₂—NH—**, *—(CH₂)₄—O—**, *—(CH₂)₆—O—**, *—(CH₂)—O— (CH₂)₂—O—**, *—CONH—(CH₂)₃—O—**, *—CH₂CH(OH)CH₂—O—**, and *—CH₂CH₂OCONH(CH₂)₃—O—** (in which * indicates the connecting site on the polymer main chain side and ** indicates the connecting site on the (meth)acryloyl group side).

The suffix m represents 0 or 1.

X represents a hydrogen atom or methyl group, preferably hydrogen atom from the standpoint of curing reactivity.

The group A represents a repeating unit derived from arbitrary vinyl monomer. The repeating unit is not specifically limited so far as it is a constituent of a monomer copolymerizable with hexafluoropropylene. The repeating unit may be properly selected from the standpoint of adhesion to substrate, Tg of polymer (contributing to film hardness), solubility in solvent, transparency, slipperiness, dustproofress, stainproofress, etc. The repeating unit may be composed of a single or a plurality of vinyl monomers depending on the purpose.

Preferred examples of the aforementioned vinyl monomer include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether, vinyl esters such as vinyl acetate, vinyl propionate and vinyl butyrate, (meth)acrylates such as methyl (meth)acrylate, ethyl(meth)acrylate, hydroxyethyl(meth)acrylate, glycidyl methacrylate, allyl (meth)acrylate and (meth)acryloyloxypropyl trimethoxysilane, styrene derivatives such as styrene and p-hydroxymethylstyrene, unsaturated carboxylic acids such as crotonic acid, maleic acid and itaconic acid, and derivatives thereof. More desirable among these vinyl monomers are vinyl ether derivatives and vinyl ester derivatives. Particularly preferred among these vinyl monomers are vinyl ether derivatives.

The suffixes x, y and z each represent the molar percentage of the respective constituent component and satisfy the relationships 30≦x≦60, 5≦y≦70 and 0≦z≦65, preferably 35≦x≦55, 30≦y≦60 and 0≦z≦20, particularly 40≦x≦55, 40≦y≦55 and 0≦z≦10.

A particularly preferred embodiment of the copolymer to be used in the invention is one represented by the formula (2).

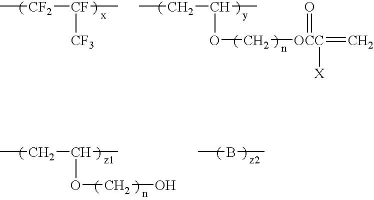

In the formula (2), X, x and y and their preferred range are as defined in the formula (1).

The suffix n represents an integer of from not smaller than 2 to not greater than 10, preferably from not smaller than 2 to not greater than 6, particularly from not smaller than 2 to not greater than 4.

The group B represents a repeating unit derived from arbitrary vinyl monomer. The repeating unit may be composed of a single composition or a plurality of compositions. Examples of the repeating unit include those listed above with reference to the group A in the formula (1).

The suffixes z1 and z2 each represent the molar percentage of the respective repeating unit and satisfy the relationship 0≦z1≦65 and 0≦z2≦65, preferably 0≦z1≦30 and 0≦z2≦10, particularly 0≦z1≦10 and 0≦z2≦5.

Specific examples of the copolymer represented by the formula (1) or (2) include those listed in JP-A-2004-45462, paragraphs (0043)-(0047). For the details of the synthesis of the copolymer represented by the formula (1) or (2), too, reference can be made to the above cited patents.

The low refractive index layer of the anti-reflection film of the invention is a cured layer formed by spreading a composition comprising at least a curable composition mainly composed of a fluorine-containing polymer containing fluorine atoms in an amount of from 35 to 80% by weight and containing crosslinkable or polymerizable groups and then curing the coat layer. The fluorine-containing polymer preferably is a copolymer containing a fluorine-containing vinyl monomer polymerizing unit and a polymerizing unit having (meth)acryloyl group in its side chain and having a main chain composed of only carbon atom wherein the refractive index of the low refractive index layer falls within a range of from 1.30 to 1.55 to keep the desired refractive index and transparency of the low refractive index layer over an extended period of time.

### <Curable Compound>

As the curable compound to be incorporated as a part of the binder component of the low refractive index layer there is preferably used a (meth)acrylate monomer. Examples of the (meth)acrylate monomer include esters of polyvalent alcohol with (meth)acrylic acid (e.g., ethylene glycol di(meth)acrylate, butanediol di(meth)acrylate, hexanediol di(meth)acrylate, 1,4-cyclohexane diacrylate, penaerythritol tetra(meth)acrylate), pentaerthritol tri(meth)acrylate, trimethylolpropane tri(meth)acrylate, dipentaerythritol tetra(meth)acrylate, dipentaerythritol penta(meth)acrylate, dipentaerythritol hexa(meth)acrylate, 1,2,3-cyclohexane tetramethacrylate, polyurethane polyacrylate, polyester polyacrylate, the aforementioned ethylene oxide modification products, vinyl benzene, derivatives thereof (e.g., 1,4-divinyl benzene, 4-vinylbenzoic acid-2-acryloylethyl ester, 1,4-divinylcyclohexanone), vinylsulfones (e.g., divinylsulfone), acrylamides (e.g., methylene bisacrylamide) and methacrylamides. The aforementioned monomers may be used in combination of two or more thereof. The added amount of these monomers may be adjusted by the content of materials having a low refractive index such as hollow particulate material and is preferably from 0 to 70% based on the total weight of the low refractive index layer. When the added amount of these monomers falls within the above defined range, the refractive index of the layer cannot be raised, making it possible to design the desirable anti-reflection layer.

### <Particulate Inorganic Material>

The low refractive index layer of the invention may comprise at least one particulate inorganic material incorporated therein.

The spread of the particulate inorganic material is preferably from 1 mg/m² to 100 mg/m², more preferably from 5 mg/m² to 80 mg/m², even more preferably from 10 mg/m² to 60 mg/m² to exert an effect of improving scratch resistance and inhibit the occurrence of fine roughness on the surface of the low refractive index layer and hence keep the external appearance such as black tone and density and the integrated reflectance good.

The particulate inorganic material preferably has a low refractive index because it is incorporated in the low refractive index layer.

Examples of the particulate inorganic material include particulate magnesium fluoride, and particulate silica. Particularly preferred among these particulate inorganic materials is particulate silica from the standpoint of refractive index, dispersion stability and cost. The average particle diameter of the particulate silica is preferably from not smaller than 30% to not greater than 150%, more preferably from not smaller than 35% to not greater than 80%, even more preferably from 40% to not greater than 60% of the thickness of the low refractive index layer to inhibit the occurrence of fine roughness on the surface of the low refractive index layer and hence keep the external appearance such as black tone and density and the integrated reflectance good. In some detail, when the thickness of the low refractive index layer is 100 nm, the particle diameter of the particulate silica is preferably from not smaller than 30 nm to not greater than 100 nm, more preferably from not smaller than 35 nm to not greater than 80 nm, even more preferably from not smaller than 40 nm to not greater than 60 nm.

The particulate silica may be crystalline or amorphous. The particulate silica may be monodisperse or may be composed of agglomerated particles so far as they have a predetermined particle diameter. The shape of the particulate silica is most preferably sphere but may be amorphous. The aforementioned properties of the particulate silica can be applied to other particulate inorganic materials.

For the measurement of the average particle diameter of the particulate inorganic material, a coulter counter may be used.

In order to further reduce the rise of the refractive index of the low refractive index layer, a hollow particulate silica is preferably used. The refractive index of the hollow particulate silica is preferably from 1.17 to 1.40, more preferably from 1.17 to 1.35, even more preferably from 1.17 to 1.30. The refractive index used herein means the refractive index of the entire particulate material rather than the refractive index of only the shell silica constituting the hollow particulate silica. Supposing that the radius of the bore of the particle is a and the radius of the shell of the particle is b, the percent void x represented by the following numerical formula (IV) is preferably from 10% to 60%, more preferably from 20% to 60%, most preferably from 30% to 60%.

x=(4πa³/3)/(4πb³/3)×100 (IV)

As the refractive index of the hollow particulate silica decreases and the percentage void of the hollow particulate silica rises, the thickness of the shell decreases. Therefore, particulate materials having a refractive index as low as less than 1.17 are impossible from the standpoint of scratch resistance.

For the measurement of the refractive index of these hollow particulate silica materials, an Abbe refractometer (produced by ATAGO CO., LTD.) was used.

The aforementioned particulate silica (hereinafter referred to as “large particle size particulate silica”) may be used in combination with a particulate silica having an average particle diameter of less than 25% of the thickness of the low refractive index layer (hereinafter referred to as “small particle size particulate silica”).

The small particle size particulate silica can be present in the gap between the large size silica particles and thus can act as a retainer for large particle diameter particulate silica.

In the case where the thickness of the low refractive index layer is 100 nm, the average particle diameter of the small particle diameter particulate silica is preferably from not smaller than 1 nm to not greater than 20 mm, more preferably from not smaller than 5 nm to not greater than 15 mm, particular from not smaller than 10 nm to not greater than 15 nm. The use of such a particulate silica is advantageous in material cost and effect of retainer.

The particulate silica may be subjected to physical surface treatment such as plasma discharge and corona discharge or chemical surface treatment with a surface active agent, coupling agent or the like to enhance the stability of dispersion in the dispersion or coating solution or the affinity for or the bonding properties with the binder component. As the coupling agent there is preferably used an alkoxy metal compound (e.g., titanium coupling agent, silane coupling agent). Particularly effective among these surface treatments is silane coupling treatment.

The aforementioned coupling agent is used as a surface treatment for the inorganic filler in the low refractive index layer to effect surface treatment before the preparation of the layer coating solution. The coupling agent is preferably incorporated as additive in the low refractive index layer during the preparation of the layer coating solution.

It is preferred that the particulate silica be previously dispersed in the medium to reduce the burden of surface treatment.

### <Organosilane, Sol Component>

The coating solution constituting low refractive index layer constituting the anti-reflection film of the invention preferably comprises at least one of organosilane compound and hydrolyzate and partial condensate thereof, i.e., so-called gel component (hereinafter referred to as such) incorporated therein from the standpoint of scratch resistance. The coating solution comprising such a sol component is spread, dried, and then condensed at the heating step to form a cured material which acts as a binder for the low refractive index layer. In the case where the cured material has a polymerizable unsaturated bond, the cured material is irradiated with active light rays to form a binder having a three-dimensional structure. The formation of a sol-gel layer comprising as a main component a sol component obtained from a single or a plurality of organosilane compounds makes it possible to obtain a low refractive index layer excellent in scratch resistance.

The organosilane compound is preferably one represented by the following formula (1).

(R¹⁰)ₘSi(X)₄₋ₘ (1)

In the formula (1), R¹⁰ represents a substituted or unsubstituted alkyl or aryl group. Examples of the alkyl group include methyl, ethyl, propyl, isopropyl, hexyl, decyl, and hexadecyl. The alkyl group preferably has from 1 to 30, more preferably from 1 to 16, particularly from 1 to 6 carbon atoms. Examples of the aryl group include phenyl, and naphthyl. Preferred among these aryl groups is phenyl.

X represents a hydroxyl group or hydrolyzable group. Examples of these groups include alkoxy groups (preferably alkoxy groups having from 1 to 5 carbon atoms such as methoxy and ethoxy), halogen atoms (e.g., Cl, Br, I), and groups represented by R²COO (in which R² is preferably a hydrogen atom or C₁-C₅alkyl group such as CH₃COO and C₂H₅COO). Preferred among these groups are alkoxy groups. Particularly preferred among these alkoxy groups are methoxy and ethoxy.

The suffix m represents an integer of from 1 to 3, preferably 1 or 2, particularly 1.

The plurality of R¹⁰'s or X's, if any, may be the same or different.

The substituents on R¹⁰ are not specifically limited but may be halogen atoms (e.g., fluorine, chlorine, bromine), hydroxyl groups, mercapto groups, carboxyl groups, epoxy groups, alkyl groups (e.g., methyl, ethyl, i-propyl, propyl, t-butyl), aryl groups (e.g., phenyl, naphthyl), aromatic heterocyclic groups (e.g., furyl, pyrazolyl, pyridyl), alkoxy groups (e.g., methoxy, ethoxy, i-propoxy, hexyloxy), aryloxy groups (e.g., phenoxy), alkylthio group (e.g., methylthio, ethylthio), alylthio group (e.g., phenylthio), alkenyl groups (e.g., vinyl, 1-propenyl), acyloxy groups (e.g., acetoxy, acryloyloxy, methacryloxy), alkoxycarbonyl groups (e.g., methoxycarbonyl, ethoxycarbonyl), aryloxycarbonyl groups (e.g., phenoxycarbonyl), carbamoyl groups (e.g., carbamoyl, N-methylcarbamoyl, N,N-dimethylcarbamoyl, N-methyl-N-octylcarbamoyl), and acylamino groups (acetylamino, benzoylamino, acrylamino, methacryl amino). These substituents may be further substituted.

At least one of the plurality of R¹⁰ 's, if any, is preferably a substituted or unsubstituted alkyl or aryl group. In particular, an organosilane compound having a vinyl-polymerizable substituent represented by the following formula (3) is preferred.

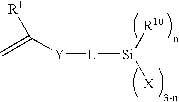

In the formula (3), R¹ represents a hydrogen atom, methyl group, methoxy group, alkoxycarbonyl group, cyano group, fluorine atom or chlorine atom. Examples of the alkoxycarbonyl group include methoxycarbonyl group, and ethoxycarbonyl group. Preferred among these groups are hydrogen atom, methyl group, methoxy group, methoxycarbonyl group, cyano group, fluorine atom, and chlorine atom. More desirable among these groups are hydrogen atom, methyl group, methoxycarbonyl group, fluorine atom, and chlorine atom. Particularly preferred among these groups are hydrogen atom and methyl group.

Y represents a single bond, *—COO—**, *—CONH—** or *—O—**, preferably single bond, *—COO—** or *—CONH—**, more preferably single bond or *—COO—**, particularly *—COO—**. The symbol * indicates the position at which the group is connected to ═C(R¹)—. The symbol ** indicates the position at which the group is connected to L.

L represents a divalent connecting chain. Specific examples of the divalent connecting chain include substituted or unsubstituted alkylene or arylene group, substituted or unsubstituted alkylene group having a connecting group (e.g., ether, ester, amide) therein, and substituted or unsubstituted arylene group having a connecting group therein. Preferred among these divalent connecting chains are substituted or unsubstituted alkylene or arylene group, and substituted or unsubstituted alkylene group having a connecting group therein. More desirable among these divalent connecting chains are unsubstituted alkylene group, unsubstituted arylene group, and substituted or unsubstituted alkylene group having a connecting group therein. Particularly preferred among these divalent connecting chains are unsubstituted alkylene group, and substituted or unsubstituted alkylene group having a connecting group therein. Examples of the substituents on these groups include halogen atoms, hydroxyl groups, mercapto groups, carboxyl groups, epoxy groups, alkyl groups, and aryl groups. These substituents may be further substituted.

The suffix n represents 0 or 1. The plurality of X's, if any, may be the same or different. The suffix n is preferably 0.

R¹⁰ is as defined in the formula (1). R¹⁰ is preferably a substituted or unsubstituted alkyl or aryl group, more preferably unsubstituted alkyl or aryl group.

X is as defined in the formula (1). X is preferably a halogen atom, hydroxyl group or unsubstituted alkoxy group, more preferably chlorine, hydroxyl group or unsubstituted C₁-C₆alkoxy group, even more preferably hydroxyl group or C₁-C₃ alkoxy group, particularly methoxy group.

Two or more of the compounds of the formulae (1) and (3) may be used in combination. Specific examples of the compounds represented by the formulae (1) and (3) will be given below, but the invention is not limited thereto.

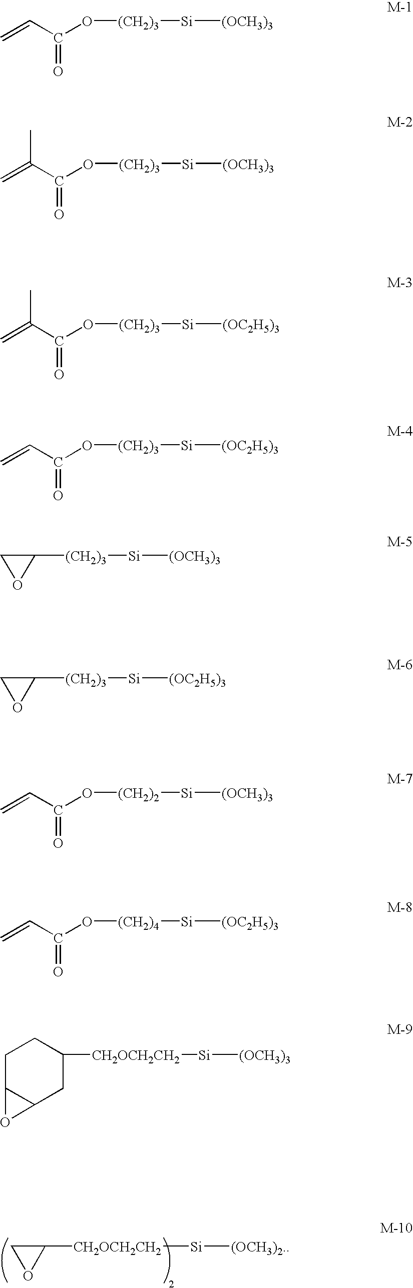

Particularly preferred among these compounds are (M-1), (M-2) and (M-5).

The hydrolyzation reaction and condensation reaction of the organosilane are normally effected in the presence of a catalyst. Examples of the catalyst employable herein include inorganic acids such as hydrochloric acid, sulfric acid and nitric acid, organic acids such as oxalic acid, acetic acid, formic acid, methanesulfonic acid and toluenesulfonic acid, inorganic bases such as sodium hydroxide, potassium hydroxide and ammonia, organic bases such as triethylamine and pyridine, metal alkoxides such as triisopropoxy aluminum and tetrabutoxy zirconium, and metal chelate compounds comprising a metal such as zirconium, titanium and aluminum as a central metal. Preferred among these inorganic acids are hydrochloric acid and sulfuric acid. Preferred among these inorganic acids are those having an acid dissociation constant {pKa value (25° C.)} of 4.5 or less in water. More desirable among these organic acids are hydrochloric acid, sulfuric acid and organic acid having an acid dissociation constant of 3.0 or less in water. Particularly preferred among these organic acids are hydrochloric acid, sulfuric acid and organic acid having an acid dissociation constant of 2.5 or less in water. Even more desirable among these organic acids are those having an acid dissociation constant of 2.5 or less in water. In some detail, methanesulfonic acid, oxalic acid, phthalic acid and malonic acid are more desirable, particularly oxalic acid.

As the metal chelate compound there may be used one having an alcohol represented by the formula R³OH (in which R³ represents a C₁-C₁₀alkyl group) and a compound represented by the formula R⁴COCH₂COR⁵ (in which R⁴ represents a C₁-C₁₀ alkyl group and R⁵ represents a C₁-C₁₀ alkyl group or C₁-C₁₀ alkoxy group) as a ligand and a metal selected from the group consisting of zirconium, titanium and aluminum as a central metal without any limitation. Two or more metal chelate compounds may be used in combination if they fall within this category. The metal chelate compound to be used in the invention is preferably selected from the group consisting of compounds represented by the following formulae:

Zr(OR³)ₚ₁(R⁴COCHCOR⁵)ₚ₂;

Ti(OR³)_{q1}(R⁴COCHCOR⁵)_{q2}; and

Al(OR³)ᵣ₁(R⁴COCHCOR⁵)ᵣ₂

The metal chelate compound of the invention acts to accelerate the condensation reaction of hydrolyzate and/or partial condensate of the organosilane compound.

R³ and R⁴ in the metal chelate compound may be the same or different and each represent a C₁-C₁₀ alkyl group such as ethyl, n-propyl, i-propyl, n-butyl, sec-butyl, t-butyl and n-pentyl or phenyl. R⁵ represents the same C₁-C₁₀ alkyl group or C₆-C₁₀ aryl group as defined above or C₁-C₁₀ alkoxy group such as methoxy, ethoxy, n-propoxy, i-propoxy, n-butoxy, sec-butoxy and t-butoxy. The suffixes p1, p2, q1, q2, r1 and r2 in these formulae each represent an integer determined to satisfy the numerical formulae: P1+p2=4, q1+q2=4 and r1+r2=3.

Specific examples of these metal chelate compounds include zirconium chelate compounds such as tri-n-butoxy ethyl acetoacetate zirconium, di-n-butoxybis(ethyl acetoacetate)zirconium, n-butoxytris(ethylaceto acetate)zirconium, tetrakis(n-propylacetoacetate) zirconium, tetrakis(acetylacetoacetate)zirconium and tetrakis(ethylacetoacetate)zirconium, titanium compounds such as diisopropoxy bis(ethylacetoacetate) titanium, diisopropoxy bis(acetylacetate)titanium and diisopropoxy bis(acetylacetone)titanium, and aluminum chelate compounds such as diisopropoxyethyl acetoacetate aluminum, diisopropoxyacetylacetonate aluminum, isopropoxy bis(ethylacetoacetate)aluminum, isoproposy bis(acetylacetonate)aluminum, tris(ethyl acetoacetate)aluminum, tris(acetylacetonate)aluminum and monoacetyl acetonate bis(ethylacetoacetate) aluminum.

Preferred among these metal chelate compounds are tri-n-butoxyethyl acetoacetate zirconium, diisopropoxy bis(acetylacetonate)titanium, diisopropoxy ethyl acetoacetate aluminum and tris(ethylacetoacetate) aluminum. These metal chelate compounds may be used singly or in combination of two or more thereof. Alternatively, these metal chelate compounds may be used in the form of partial hydrolyzate.

The coating solution of the low refractive index layer to be used in the invention comprises composition containing a sol component and a metal chelate compound incorporated therein. Further, the coating solution of the low refractive index layer preferably comprises either or both of a β-diketone compound and a β-ketoester compound incorporated therein. This will be further described hereinafter.

In the invention, at least any of β-diketone and β-ketoester compounds represented by the formula R⁴COCH₂COR⁵ is used. These compounds each act as a stability improver for the composition to be used in the invention. In other words, it is thought that the coordination of these compounds to the metal atoms in the aforementioned metal chelate compound (at least any of zirconium, titanium and aluminum compounds) makes it possible to prevent these metal chelate compounds from accelerating the condensation reaction of the sol component of organosilane compound and hence enhance the storage stability of the resulting composition. R⁴ and R⁵ constituting the β-diketone compound and β-ketoester compound are as defined in the aforementioned metal chelate compound.

Specific examples of the β-diketone compound and β-ketoester compound include acetyl acetone, methyl acetoacetate, ethyl acetoacetate, n-propyl acetoacetate, i-propyl acetoacetate, n-butyl acetoacetate, sec-butyl acetoacetate, t-butyl acetoacetate, 2,4-hexane-dione, 2,4-heptane-dione, 3,5-heptane-dione, 2,4-octane-dione, 2,4-nonane-dione, and 5-methyl-hexane-dione. Preferred among these compounds are ethyl acetoacetate and acetyl acetone. Particularly preferred among these compounds is acetyl acetone. These α-diketone compounds and/or β-ketoester compounds may be used singly or in combination of two or more thereof.

In the invention, the β-diketone compound and β-ketoester compound are preferably used in an amount of 2 mols or more, more preferably from 3 to 20 mols per mol of metal chelate compound from the standpoint of the storage stability of the compound thus obtained.

The content of the sol component of organosilane compound in the surface layer, which is a relatively thin layer, is preferably small. The content of the sol component of organosilane compound in the underlying layers, which are relatively thick layers, is preferably great. The content of the sol component in the surface layer such as low refractive index layer is preferably from 0.1 to 50% by weight, more preferably from 0.5 to 20% by weight, most preferably from 1 to 10% by weight based on the total solid content of the layer.

The content of the sol component in the layers other than low refractive index layer is preferably from 0.001 to 50% by weight, more preferably from 0.01 to 20% by weight, even more preferably from 0.05 to 10% by weight, particularly from 0.1 to 5% by weight based on the total solid content of the layers.

In a preferred embodiment of the invention, a composition comprising the sol component of organosilane compound and a metal chelate compound is firstly prepared. To the composition is then added at least any of a β-diketone compound and a β-ketoester compound. The solution is then incorporated in the coating solution of at least one of hard coat layer and low refractive index layer. The coating solution is then spread.

The content of the sol component of organosilane compound in the low refractive index layer is preferably from 5 to 100% by weight, more preferably from 5 to 40% by weight, even more preferably from 8 to 35% by weight, particularly from 10 to 30% by weight based on the weight of the fluorine-containing polymer from the standpoint of development of effect, prevention of rise of refractive index and maintenance of film shape and surface conditions.

The low refractive index layer preferably is preferably a cured layer formed by spreading a curable composition comprising (A) a fluorine-containing polymer described with reference to <Fluorine-containing polymer>, (B) a particulate inorganic material having an average particle diameter of from not smaller than 30% to not greater than 150% of the thickness of the low refractive index layer and a hollow structure refractive index of from 1.17 to 1.40 described with reference to <Particulate inorganic material> and (C) at least any of hydrolyzate and partial condensate of organosilane represented by the formula (1) produced in the presence of an acid catalyst or metal chelate compound described with reference to <Organosilane, sol component>, and then curing the coat layer to keep the desired low refractive index and transparency of the layer over an extended period of time.

### <Stainproofing Agent, Lubricant>

For the purpose of providing properties such as stainproofness, water resistance, chemical resistance and slipperiness, a known silicone-based or fluorine-based stainproofing agent, a lubricant or the like may be properly added. These additives, if any, are preferably added in an amount of from 0.01 to 20% by weight, more preferably from 0.05 to 10% by weight, particularly from 0.1 to 5% by weight based on the solid content of the low refractive index layer.

Preferred examples of the silicone-based compound include those containing a plurality of dimethyl silyloxy units as repeating units and having substituents at the end of chain and in side chains thereof. The compound chain containing dimethyl silyloxy as repeating unit may contain structural units other than dimethyl silyloxy. The substituents may be the same or different. It is preferred that there be a plurality of substituents. Preferred examples of the substituents include groups containing acryloyl group, methacryloyl group, aryl group, cinnamoyl group, epoxy group, oxetanyl group, hydroxyl group, fluoroalkyl group, polyoxyalkylene group, carboxyl group, amino group, etc. The molecular weight of the silicone-based compound is not specifically limited but is preferably 100,000 or less, particularly 50,000 or less, most preferably from 3,000 to 30,000. The content of silicon atoms in the silicone-based compound, too, is not specifically limited but is preferably 18.0% by weight or more, particularly from 25.0 to 37.8% by weight, most preferably from 30.0 to 37.0% by weight. Preferred examples of the silicone-based compound include X-22-174DX, X-22-2426, X-22-164B, X-22-164C, X-22-170DX, X-22-176D, and X-22-1821 (produced by Shin-Etsu Chemical Co., Ltd.), FM-0725, FM-7725, FM-4421, FM-5521, FM-6621 and FM-1121 (produced by Chisso Corporation), and DMS-U22, RMS-033, RMS-083, UMS-182, DMS-H21, DMS-H31, HMS-301, FMS121, FMS123, FMS131, FMS141 and FMS221 (produced by Gelest, Inc.). However, the invention is not limited to these products.

As the fluorine-based compound there is preferably used a compound having a fluoroalkyl group. The fluoroalkyl group preferably has from 1 to 20 carbon atoms, more preferably from 1 to 10 carbon atoms, and may have a straight-chain structure (e.g., —CF₂CH₃, —CH₂(CF₂)₄H, —CH₂(CF₂)₈CF₃, —CH₂CH₂(CF₂)₄H), a branched structure (e.g., CH(CF₃)₂, CH₂CF(CF₃)₂, CH(CH₃)CF₂CF₃, CH(CH₃)(CF₂)₅CF₂H) or an alicyclic structure (preferably 5-membered or 6-membered ring such as perfluorocyclohexyl group, perfluorocyclopentyl group or alkyl group substituted thereby). The fluoroalkyl group may have an ether bond (e.g., CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H). A plurality of the fluoroalkyl groups may be incorporated in the same molecule.

The fluorine-based compound preferably further contain substituents contributing to the formation of bond to the low refractive index layer or the compatibility with the low refractive index layer. These substituents may be the same or different. It is preferred that there be a plurality of these substituents. Preferred examples of these substituents include acryloyl group, methacryloyl group, vinyl group, aryl group, cinnamonyl group, epoxy group, oxetanyl group, hydroxyl group, polyoxyalkylene group, carboxyl group, and amino group. The fluorine-based compound may be used in the form of polymer or oligomer with a fluorine-free compound. The fluorine-based compound may be used without any limitation on the molecular weight. The content of fluorine atoms in the fluorine-based compound is not specifically limited but is preferably 20% by weight or more, particularly from 30 to 70% by weight, most preferably from 40 to 70% by weight. Preferred examples of the fluorine-based compound include R-2020, M-2020, R3833 and M-3833 (produced by DAIKIN INDUSTRIES, Ltd.), and Megafac F-171, Megafac F-172 and Megafac F-179A, Diffenser MCF-300 (produced by DAINIPPON INK AND CHEMICALS, INCORPORATED). However, the invention is not limited to these products.

### <Dustproofing Agent, Antistatic Agent>

For the purpose of providing properties such as dustproofing agent and antistatic properties, a dustproofing agent such as known cationic surface active agent and polyoxyalkylene-based compound, antistatic agent or the like may be properly added. Referring to these dustproofing agents and antistatic agents, the aforementioned silicone-based compound or fluorine-based compound may have its structural unit to act partly to perform such a performance. These additives, if any, are preferably added in an amount of from 0.01 to 20% by weight, more preferably from 0.05 to 10% by weight, particularly from 0.1 to 5% by weight based on the total solid content of the low refractive index layer-forming composition. Preferred examples of these compounds include Megafac F-150 (produced by DAINIPPON INK AND CHEMICALS, INCORPORATED), and SH-3748 (produced by Toray Dow Corning Co., Ltd.). However, the invention is not limited to these products.

### <Polymerization Initiator>

Examples of the polymerization initiator which generates radicals when irradiated with ionized radiation include acetophenones, benzoins, benzophenones, phosphine oxides, ketals, anthraquinones, thioxanthones, azo compounds, peroxides, 2,3-dialkyl dione compounds, disulfide compounds, fluoroamine compounds, and aromatic sulfoniums. Examples of the acetophenones include 2,2-diethoxyacetophenone, p-dimethylacetophenone, 1-hydroxydimethylphenylketone, 1-hydroxycyclohexylphenylketone, 2-methyl-4-methylthio-2-morpholinopropiophenone, and 2-benzyl-2-dimethylamino-1-(4-morpholinophenyl)-butanone. Examples of the benzoins include benzoinbenzenesulfonic acid ester, benzointoluenesulfonic acid ester, benzoinmethyl ether, benzomethyl ether, and benzoin isopropyl ether. Examples of the benzophenones include benzophenone, 2,4-dichlorobenzophenone, 4,4-dichloro benzophenone, and p-chlorobenzophenone. Examples of the phosphine oxides include 2,4,6-trimethylbenzoin diphenyl phosphine oxide.

Various examples of polymerization initiator are disclosed also in Kazuhiro Takahashi, “Saishin UV Kouka Gijutsu (Modern UV Curing Technique)”, page 159, Technical Information institute Co., Ltd., 1991. These polymerization initiators are useful in the invention.

Preferred examples of commercially available ionized radiation-cleavable ionized radiation radical polymerization initiators include “Irgacure 651, 184, 907” (produced by Ciba Specialty Chemicals Inc.).

The ionized radiation polymerization initiator is preferably used in an amount of from 0.1 to 15 parts by weight, more preferably from 1 to 10 parts by weight based on 100 parts by weight of the polyfunctional monomer.

In addition to the ionized radiation polymerization initiator, a photosensitizer may be used. Specific examples of the photosensitizer include n-butylamine, triethylamine, tri-n-butylphosphine, Michler's ketone, and thioxanthone.

As the polymerization initiator which generates radicals when heated there may be used an organic or inorganic peroxide, an organic azo or diazo compound or the like.

Specific examples of the organic peroxide include benzoyl peroxide, halogen benzoyl peroxide, lauroyl peroxide, acetyl peroxide, dibutyl peroxide, cumene hydroperoxide, and butyl hydroperoxide. Specific examples of the inorganic peroxide include hydrogen peroxide, ammonium persulfate, and potassium persulfate. Specific examples of the azo compound include 2-azo-bis-isobutylnitrile, 2-azo-bis-propionitrile, and 2-azo-bis-cyclohexanedinitrile. Specific examples of the diazo compound include diazoaminobenzene, and p-nitrobenzene diazonium.

### <Solvent>

As the solvent to be used in the coating composition for forming the low refractive index layer of the invention there may be used any solvent selected from the standpoint of capability of dissolving or dispersing the various components therein, ease of forming uniform surface conditions at the coating step and drying step, assurance of liquid preservability, provision of proper saturated vapor pressure. From the standpoint of burden of drying, the solvent to be used herein preferably comprises a solvent having a boiling point of 100° C. or less at ordinary pressure and room temperature as a main component and a small amount of a solvent having a boiling point of 100° C. or more for the purpose of adjusting the drying speed.

Examples of the solvent having a boiling point of 100° C. or less include hydrocarbons such as hexane (boiling point: 68.7° C.), heptane (boiling point: 98.4° C.), cyclohexane (boiling point: 80.7° C.) and benzene (boiling point: 80.1° C.), halogenated hydrocarbons such as dichloromethane (boiling point: 39.8° C.), chloroform (boiling point: 61.2° C.), carbon tetrachloride (boiling point: 76.8° C.), 1,2-dichloroethane (boiling point: 83.5° C.) and trichloroethylene (boiling point: 87.2° C.), ethers such as diethylether (boiling point: 34.6° C.), diisopropylether (boiling point: 68.5° C.), dipropylether (boiling point: 90.5° C.) and tetrahydrofurane (boiling point: 66° C.), esters such as ethyl formate (boiling point: 54.2° C.), methyl acetate (boiling point: 57.8° C.), ethyl acetate (boiling point: 77.1° C.) and isopropyl acetate (boiling point: 89° C.), ketones such as acetone (boiling point: 56.1° C.) and 2-butanone (also referred to as methyl ethylketone; boiling point: 79.6° C.), alcohols such as methanol (boiling point: 64.5° C.), ethanol (boiling point: 78.3° C.), 2-propanol (boiling point: 82.4° C.) and 1-propanol (boiling point: 97.2° C.), cyano compounds such as acetonitrile (boiling point: 81.6° C.) and propionitrile (boiling point: 97.4° C.), and carbon disulfide (boiling point: 46.2° C.). Preferred among these solvents are ketones and esters. Particularly preferred among these solvents are ketones. Particularly preferred among the ketones is 2-butanone.

Examples of the solvent having a boiling point of 100° C. or more include octane (boiling point: 125.7° C.), toluene (boiling point: 110.6° C.), xylene (boiling point: 138° C.), tetrachloroethylene (boiling point: 121.2° C.), chlorobenzene (boiling point: 131.7° C.), dioxane (boiling point: 101.3° C.), dibutylether (boiling point: 142.4° C.), isobutyl acetate (boiling point: 118° C.), cyclohexanone (boiling point: 155.7° C.), 2-methyl-4-pentanone (also referred to as “MIBK”; boiling point: 115.9° C.), 1-butanol (boiling point: 117.7° C.), N,N-dimethylformamide (boiling point: 153° C.), N,N-dimethylacetamide (boiling point: 166° C.), and dimethylsulfoxide (boiling point: 189° C.). Preferred among these solvents are cyclohexanone and 2-methyl-4-pentanone. (High refractive index layer, middle refractive index layer)

The anti-reflection film of the invention may comprise a high refractive index layer or a middle refractive index layer provided therein to provide better anti-reflection properties.

The refractive index of the high refractive index layer falls within the range of from 1.55 to 2.40. When there is a layer having a refractive index falling within this range, it means that there is present a high refractive index layer of the invention. The above defined range of refractive index is that of the refractive index of the so-called high refractive index layer or middle refractive index layer. These layers will be occasionally generically referred to as “high refractive index layer” hereinafter.

When there are present a high refractive index layer and a low refractive index layer in admixture, the layer having a higher refractive index than that of the hard coat layer or middle refractive index layer is referred to as “high refractive index layer”. The layer having a higher refractive index than that of the support, hard coat layer and middle refractive index layer and a lower refractive index than that of the high refractive index layer is referred to as “middle refractive index layer”. The refractive index of these layers can be properly adjusted by adjusting the amount of the particulate inorganic material or binder to be added.

The refractive index of the middle refractive index layer in the anti-reflection film of the invention is from 1.55 to 1.85, preferably from 1.60 to 1.75.

The refractive index of the high refractive index layer in the anti-reflection film of the invention is from 1.65 to 2.20, preferably from 1.80 to 1.95.

From the standpoint of reduction of reflectance, the middle refractive index layer preferably satisfies the following numerical relationship (II) and the high refractive index layer preferably satisfies the following numerical relationship (III).

(1/4)×0.7<n2×d2<(1/4)×1.3 (II)

(p/4)×0.7<n3×d3<(p/4)×1.3 (III)

wherein I and p each represent 1 or 2; n2 and n3 represent the refractive index of the middle refractive index layer and the high refractive index layer, respectively; and d2 and d3 represent the thickness (nm) of the middle refractive index layer and the high refractive index layer, respectively. λ indicates wavelength falling within a range of from 500 to 550 nm.

The satisfaction of the aforementioned numerical relationships (II) and (III) means that there are present l and p satisfying the numerical relationships (II) and (III), respectively, in the above defined wavelength range.

### <Particulate Inorganic Material Comprising Titanium Dioxide as a Main Component>

The aforementioned high refractive index layer comprises a particulate inorganic material comprising titanium dioxide as a main component containing at least one element selected from the group consisting of cobalt, aluminum and zirconium. The term “main component” as used herein is meant to indicate the component having the highest content (% by weight) in the components constituting the particle.

The refractive index of the particulate inorganic material mainly composed of titanium dioxide of the invention is preferably from 1.90 to 2.80, most preferably from 2.20 to 2.80. The weight-average diameter of the primary particle is preferably from 1 to 200 nm, more preferably from 2 to 100 nm, particularly from 2 to 80 nm.

The incorporation of at least one element selected from the group consisting of cobalt, aluminum and zirconium in the particulate inorganic material mainly composed of titanium dioxide makes it possible to inhibit the photocatalytic activity of titanium dioxide and hence improve the weathering resistance of the high refractive index layer.

The particulate inorganic material main composed of titanium dioxide to be used in the invention may be subjected to surface treatment. For the surface treatment, an inorganic compound containing cobalt, an inorganic compound such as Al(OH)₃ and Zr(OH)₄ or an organic compound such as silane coupling agent is used. The particulate inorganic material mainly composed of titanium dioxide of the invention may have a core/shell structure developed by surface treatment as disclosed in JP-A-2001-166104.

The shape of the particulate inorganic material mainly composed of titanium dioxide to be incorporated in the high refractive index layer is preferably grain, sphere, cube, spindle or amorphous, particularly amorphous or spindle.

### <Dispersant>

For the dispersion of the aforementioned particulate inorganic material, a dispersant may be used. In particular, a dispersant having an anionic group is preferred.

As the anionic group there may be effectively used a group having an acidic proton such as carboxyl group, sulfonic acid group (and sulfo group), phosphoric acid group (and phosphono group) and sulfonamide group or salt thereof. Preferred among these anionic groups are carboxyl group, sulfonic acid group, phosphoric acid group and salt thereof, particularly carboxyl group and phosphoric acid group. The number of anionic groups per molecule of dispersant may be 1 or more, preferably 2 or more, more preferably 5 or more, particularly 10 or more on the average. A plurality of anionic groups may be incorporated per molecule. The dispersant preferably contains a crosslinkable or polymerizable functional group.

### <High Refractive Index Layer and Forming Method Thereof>

The particulate inorganic material mainly composed of titanium dioxide to be used in the high refractive index layer is used in the form of dispersion to form the high refractive index layer.

The particulate inorganic material is dispersed in a dispersion medium in the presence of the aforementioned dispersant.

As the dispersion medium there is preferably used a liquid having a boiling point of from 60° C. to 170° C. Examples of the dispersion medium include water, alcohol, ketone, ester, aliphatic hydrocarbon, halogenated hydrocarbon, aromatic hydrocarbon, amide, ether, and ether alcohol. Preferred among these dispersion media are toluene, xylene, methyl ethyl ketone, methyl isobutyl ketone, cyclohexanone, and butanol.

Particularly preferred among these dispersion media are methyl ethyl ketone, methyl isobutyl ketone, and cyclohexanone.

The particulate inorganic material is subjected to dispersion using a dispersing machine. Examples of the dispersing machine employable herein include sand grinder mill (e.g., bead mill with pin), high speed impellor mill, pebble mill, roller mill, attritor, and colloid mill. Particularly preferred among these dispersing machines are sand grinder mill and high speed impellor mill. The particulate inorganic material may be subjected to previous dispersion. Examples of the dispersing machine to be used in previous dispersion include ball mill, three-roll mill, kneader, and extruder.

The particulate inorganic material dispersion preferably stays finely divided in the dispersion medium as much as possible. The weight-average particle diameter of the particulate inorganic material is from 1 to 200 nm, preferably from 5 to 150 nm, more preferably from 10 to 100 nm, particularly from 10 to 80 nm.

The fine division of the particulate inorganic material to 200 nm or less makes it possible to form a high refractive index layer which is not subject to loss of transparency.

The high refractive index layer to be used in the invention is preferably formed by adding a binder precursor required to form a matrix (ionized radiation-curing compound, etc.), a photopolymerization initiator or the like to a dispersion having a particulate inorganic material dispersed in a dispersion medium as previously mentioned to obtain a high refractive index layer-forming coating composition, spreading the high refractive index layer-forming coating composition over a transparent support, and then subjecting the ionized radiation-curing compound (e.g., polyfunctional monomer or oligomer) to crosslinking reaction or polymerization reaction to cause curing of the coating composition.

The polymerization reaction of the photopolymerizable polyfunctional monomer is preferably effected in the presence of a photopolymerization initiator. As the photopolymerization initiator there is preferably used a photoradical polymerization initiator or photocation polymerization initiator, particularly photocation polymerization initiator. As the photoradical polymerization initiator there may be used the same material as mentioned above with reference to hard coat layer.

The binder to be incorporated in the high refractive index layer preferably further has a silanol group. When the binder further has a silanol group, the physical strength, chemical resistance and weathering resistance of the high refractive index layer can be further improved.

The silanol group can be incorporated in the binder by adding a compound having a crosslinkable or polymerizable functional group to the aforementioned high refractive index layer-forming coating composition, spreading the coating composition over a transparent support, and then subjecting the aforementioned dispersant or polyfunctional monomer or oligomer to crosslinking reaction or polymerization reaction.

The binder in the high refractive index layer preferably has an amino group or quaternary ammonium group. The monomer having an amino group or quaternary ammonium group keeps the particulate inorganic material well dispersed in the high refractive index layer, making it possible to prepare a high refractive index layer excellent in physical strength, chemical resistance and weathering resistance.

In the structure of the crosslinked or polymerized binder, the main chain of the polymer is crosslinked or polymerized. Examples of the polymer chain include polyolefins (saturated hydrocarbon), polyethers, polyureas, polyurethanes, polyesters, polyamines, polyamides, and melamine resins. Preferred among these polymer chains are polyolefin main chain, polyether main chain and polyurea main chain. More desirable among these polymer chains are polyolefin main chain and polyether main chain. Most desirable among these polymer chains is polyolefin main chain.

The binder is preferably a copolymer having a repeating unit having an anionic group and a repeating unit having a crosslinked or polymerized structure. The proportion of the repeating unit having an anionic group is preferably from 2 to 96 mol-%, more preferably from 4 to 94 mol-%, most preferably from 6 to 92 mol-%. The repeating unit may have two or more anionic groups. The proportion of the repeating unit having a crosslinked or polymerized structure in the copolymer is preferably from 4 to 98 mol-%, more preferably from 6 to 96 mol-%, most preferably from 8 to 94 mol-%.

The high refractive index layer may comprise a finely particulate material incorporated therein besides the aforementioned particulate inorganic material mainly composed of titanium dioxide.

The content of the particulate inorganic material in the high refractive index layer is preferably from 10 to 90% by weight, more preferably from 15 to 80% by weight, particularly from 15 to 75% by weight based on the weight of the high refractive index layer. Two or more particulate inorganic materials may be incorporated in combination in the high refractive index layer.

In the case where the low refractive index layer is provided on the high refractive index layer, the refractive index of the high refractive index layer is preferably higher than that of the transparent support.

The high refractive index layer is also preferably made of a binder obtained by the crosslinking or polymerization reaction of an ionized radiation-curing compound containing an aromatic ring, an ionized radiation-curing compound containing a halogen element other than fluorine (e.g., Br, I, Cl), an ionized radiation-curing compound containing an element such as sulfur, nitrogen and phosphorus or the like.

In order to prepare an anti-reflection film by forming a low refractive index layer on a high refractive index layer, the refractive index of the high refractive index layer is preferably from 1.55 to 2.40, more preferably from 1.60 to 2.20, even more preferably from 1.65 to 2.10, most preferably from 1.80 to 2.00.

The high refractive index layer may comprise a resin, a surface active agent, an antistatic agent, a coupling agent, a thickening agent, a coloration inhibitor, a colorant (e.g., pigment, dye), an anti-glare particulate material, an ant-foaming agent, a leveling agent, a fire retardant, an ultraviolet absorber, an infrared absorber, an adhesion-providing agent, a polymerization inhibitor, an oxidation inhibitor, a surface modifier, an electrically-conductive particulate metal, etc. incorporated therein besides the aforementioned components (e.g., particulate inorganic material, polymerization initiator, photosensitizer).

The thickness of the high refractive index layer may be properly designed. In the case where the high refractive index layer is used as an optical interference layer as described later, the thickness of the high refractive index layer is preferably from 30 to 200 nm, more preferably from 50 to 170 nm, particularly from 60 to 150 nm.

In order to form the high refractive index layer, the crosslinking reaction or polymerization reaction of the ionized radiation-curable compound is preferably effected in an atmosphere having an oxygen concentration of 10 vol-% or less, more preferably 6 vol-% or less, particularly 2 vol-% or less, most preferably 1 vol-% or less.

### (Other Layers)

Examples of other layers which may be provided interposed between the transparent support and the hard coat layer of the invention include anti-reflection layer (to be provided in the case where there are requirements that the surface resistivity on the display side be reduced or in the case where the attachment of dust to the surface raises a problem), moistureproof layer, adhesion improving layer, and rainbow (interference) preventive layer.

These layers can be formed by known methods.

The anti-reflection film of the invention can be formed by the following method, but the invention is not limited thereto.

### (Preparation of Coating Solution)

Firstly, a coating solution containing components constituting the various layers is prepared. During this procedure, the rise of the water content in the coating solution can be inhibited by minimizing the evaporation loss of the solvent. The water content in the coating solution is preferably 5% or less, more preferably 2% or less. The inhibition of the evaporation loss of the solvent is accomplished by improving the airtightness of the tank during the agitation of the various materials which have been put therein or minimizing the contact area of the coating solution with respect to air during the movement of the coating solution. Alternatively, a unit of reducing the water content in the coating solution may be provided during or before and after spreading.

The coating solution for forming the hard coat layer, etc. are preferably filtered such that foreign matters having a size corresponding to the dry thickness (about 50 nm to 120 nm) of the layer to be formed directly on these layers (e.g., low refractive index layer, middle refractive index layer) can be removed substantially completely (90% or more). Since the light-transmitting particulate material for providing light diffusivity has a thickness equal to or greater than that of the low refractive index layer or middle refractive index layer, the aforementioned filtration is preferably conducted on the intermediate solution comprising all materials other than light-transmitting particulate material incorporated therein. In the case where no filters which can remove the aforementioned foreign matters having a small particle diameter are available, filtration is preferably conducted such that foreign matters having a size corresponding to the wet thickness (about from 1 to 10 μm) of the layer to be directly formed on these layers can be removed substantially completely. In these manners, point defects of the layer formed directly on these layers can be eliminated.

### (Coating)

Subsequently, the coating solution for forming the layers to be formed directly on the support, e.g., hard coat layer is coated (or spread) over a transparent support by a dip coating method, air knife coating method, curtain coating method, roller coating method, wire bar coating method, gravure coating method, microgravure coating method or die coating method, and then heated and dried. Thereafter, the coat layer is irradiated with light rays and/or heated to undergo curing. In this manner, a hard coat layer, etc. are formed.

If necessary, the hard coat layer may be composed of a plurality of layers. At least one of the plurality of hard coat layers may have light scattering properties while the other layers may have no light-scattering properties.

Subsequently, the coating solution for forming the low refractive index layer is spread over the hard coat layer in the same manner as mentioned above, dried to remove the solvent, and then cured by at least any of irradiation with light rays and heating to form a low refractive index layer. Depending on the purpose, the aforementioned hard coat layer may be provided with light-scattering properties. Alternatively, the aforementioned middle refractive index layer and high refractive index layer may be provided in this order between the hard coat layer and the low refractive index layer in the same manner as in the low refractive index layer. In this manner, an anti-reflection film of the invention is obtained.

Among the aforementioned various coating methods, the die coating method attaining both uniformity in spread in the crosswise direction and longitudinal direction and productivity (adaptability to high speed coating) is preferably used because it can attain both high productivity and surface conditions free from unevenness in coating to a high extent when combined with the transparent support having an improved smoothness of the invention. A die coater which is preferably used in an area having a small wet spread (20 cc/m² or less) as in the anti-reflection film of the invention will be described hereinafter.

### (Configuration of Die Coater)

FIG. 6 is a sectional view of a coater comprising a slot die used in all exemplary embodiment of the invention.

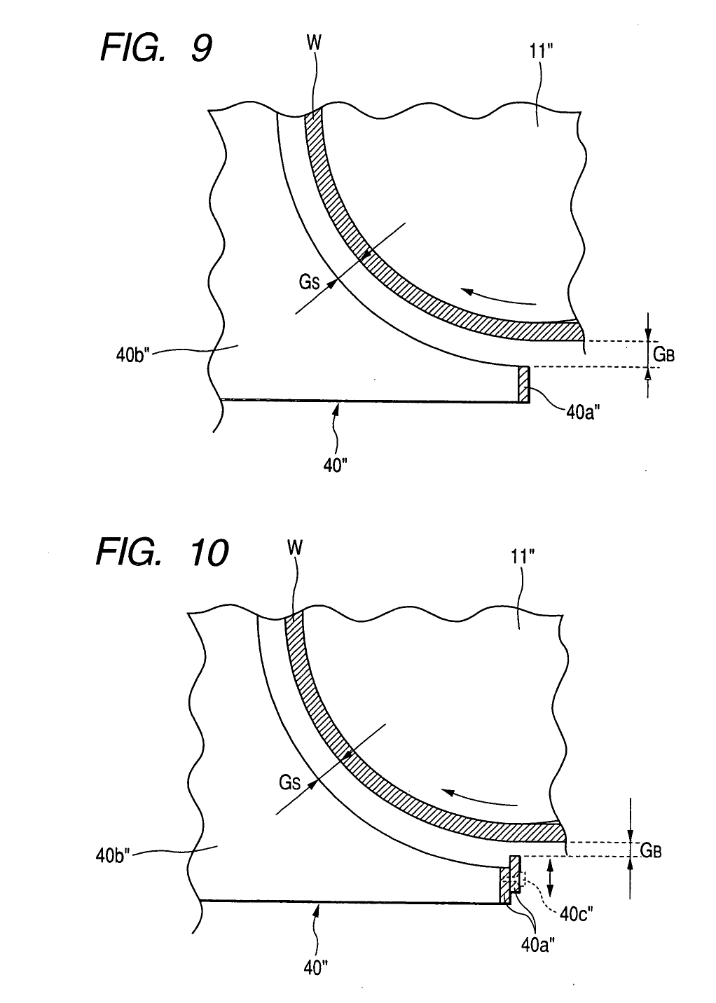

A coater 10″ is adapted to coat (or spread) a coating solution 14″ from a slot die 13″ in the form of bead 14a″ over a web W which is continuously running while being supported on a backup roller 11″ to form a coat layer 14b″ on the web W. Formed inside the slot die 13″ are a pocket 15″ and a slot 16″. The pocket 15″ has a section formed by a curve and a straight line. The section may be substantially circular as shown in FIG. 9 or semicircular. The pocket 15″ is a coating solution reservoir space extending in the crosswise direction of the slot die 13″ with its sectional shape. The effective length of extension of the space is normally equal to or somewhat longer than the coating width.

The supply of the coating solution 14″ into the pocket 15″ is conducted on the side of the slot die 13″ or on the center of the side of the slot die 13″ opposite the slot opening 16a″. The pocket 15″ comprises a plug provided therein for preventing the leakage of the coating solution 14″.

The slot 16″ is a channel for the coating solution 14″ from the pocket 15″ to the web W. The channel has a sectional shape extending in the crosswise direction of the slot die 13″ as in the pocket 15″. The width of the opening 16a″ disposed on the web side of the channel is normally adjusted to a value substantially equal to the coating width by a width limiting plate (not shown). The angle of the end of the slot 16″ with respect to the line normal to the surface of the backup roller 11″ in the web running direction is preferably from 30° to 90°.

The end lip 17″ of the slot die 13″ at which the opening 16a″ of the slot 16″ is disposed is convergent. The end of the lip 17″ forms a flat portion 18″ called land. In the land 18″, the portion disposed upstream from the slot 16″ along the running direction of web W is called upstream lip land 18a″. The portion disposed downstream from the slot 16″ along the running direction of web W is called downstream lip land 18b″.

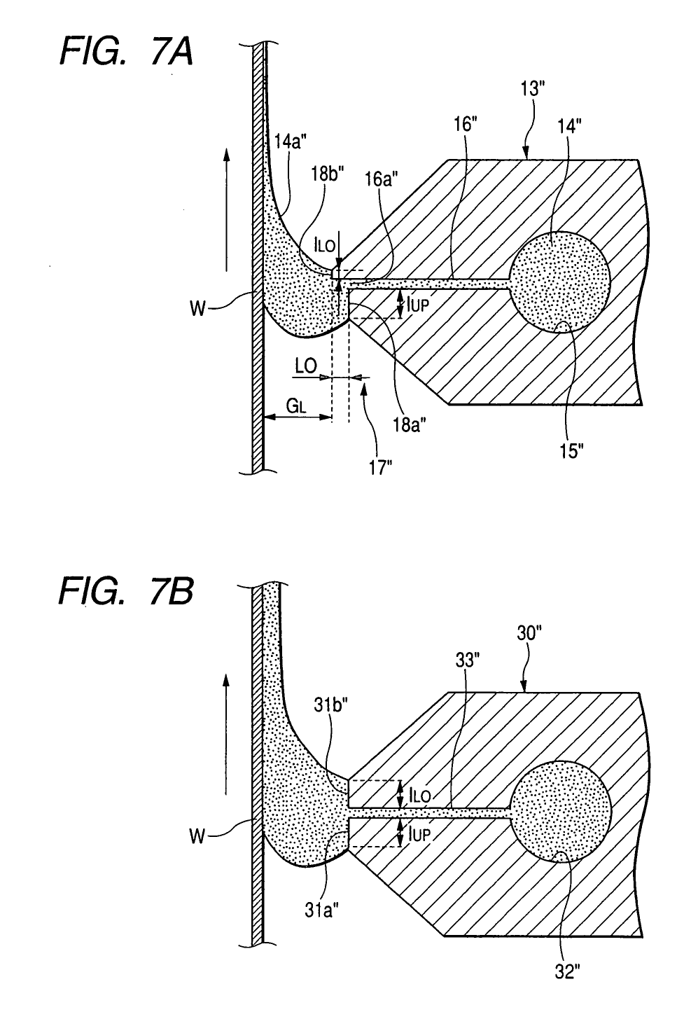

FIG. 7 illustrates the sectional shape of the slot die 13″ as compared with the related art.

FIG. 7A illustrates the slot die 13″ of the invention. FIG. 7B illustrates a related art slot due 30″. In the related art slot die 30″, the distance between the upstream lip land 31a″ and the web W and the distance between the downstream lip land 31b″ and the web W are the same as each other. In FIG. 7B, the reference numeral 32″ indicates a pocket and the reference numeral 33″ indicates a slot. In the slot die 13″ of the invention, on the contrary, the length ILO of the downstream lip land is shorter than the length of the upstream lip land. In this arrangement, spreading can be conducted to a wet thickness of 20 μm or less with a good precision.

The length IUP of the upstream lip land 18a″ is not specifically limited but is preferably from 100 μm to 1 mm. The length ILO of the downstream lip land 18b″ is from 30 μm to 100 μm, preferably from 30 μm to 80 μm, more preferably from 30 μm to 60 μm.

When the length ILO of the downstream lip land is less than 30 μm, the edge or land of the forward lip 17″ can easily break off, making it easy to cause the occurrence of streak on the coat layer and hence making spreading impossible. Another problem arises that the wet line position on the downstream side can be difficulty predetermined, making it easy for the coating solution to spread on the downstream side. It has heretofore been known that the expansion of wet by the coating solution on the downstream side means unevenness in wet line and results in the occurrence of defective shapes such as streak on the coat layer.

On the contrary, when the length ILO of the downstream lip land is more than 100 μm, the bead itself cannot be formed, making it impossible to make thin layer spreading.

Further, the downstream lip land 18b″ has an overbite configuration such that it is disposed closer to the web W than the upstream lip land 18a″. In this arrangement, the degree of vacuum can be reduced to form a bead suitable for thin layer spreading. The difference in distance from the web W between the downstream lip land 18b″ and the upstream lip land 18a″ (hereinafter referred to as “overbite length LO”) is preferably from 30 μm to 120 μm, more preferably from 30 μm to 100 μm, most preferably from 30 μm to 80 μm.

When the slot die 13″ has an overbite configuration, the gap GL between the end lip 17″ and the web W indicates the gap between the downstream lip land 18b and the web W.

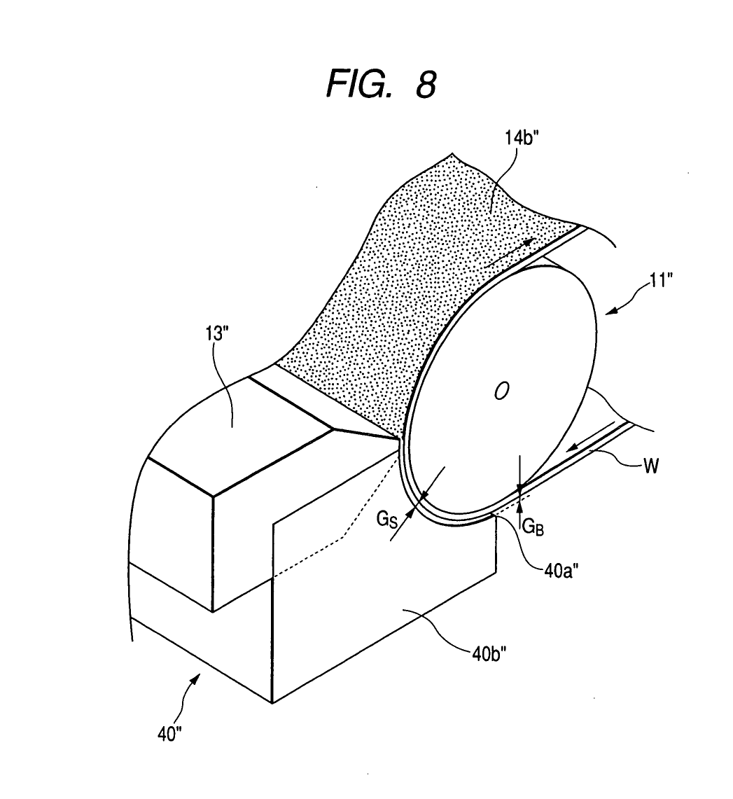

FIG. 8 is a perspective view illustrating a slot die used at the coating step in the implementation of the invention and its periphery. Disposed on the side of the slot die opposite the side on which the web W is running is a pressure-reducing chamber 40″ at a position where it doesn't come in contact with the slot die such that sufficient adjustment of pressure reduction can be made on the bead 14a″. The pressure-reducing chamber 40″ comprises a back plate 40a″ and a side plate 40b″ for maintaining the operating efficiency. There are present gaps GB and GS between the back plate 40a″ and the web W and between the side plate 40b″ and the web W, respectively.

FIGS. 9 and 10 each are a sectional view illustrating the pressure-reducing chamber 40″ and the web W which are disposed close to each other. The side plate 40b″ and the back plate 40a″ may be formed integral with the chamber as shown in FIG. 9 or may be fixed to the chamber 40c″ with a screw 40c″ so that the gap can be properly varied as shown in FIG. 10.

Regardless of the configuration, the actual space between the back plate 40a″ and the web W and between the side plate 40b″ and the web W are defined to be GB and GS, respectively. The gap GB between the back plate 40a″ and the web W in the pressure-reducing chamber 40″ indicates the gap between the uppermost end of the back plate 40a″ and the web W in the case where the pressure-reducing chamber 40″ is disposed beneath the web W and the slot die 13″ as shown in FIG. 8.

The arrangement is preferably made such that the gap GB between the back plate 40a″ and the web W is larger than the gap GL between the end lip 17″ of the slot die 13″ and the web W. In this arrangement, the change of the degree of vacuum in the vicinity of bead attributed to the eccentricity of the backup roller 11″ can be inhibited.

For example, when the gap GL between the end lip 17″ of the slot die 13″ and the web W is from 30 μm to 100 μm, the gap GB between the back plate 40a″ and the web W is preferably predetermined to be from 100 μm to 500 μm.

### (Material, Precision)

As the length of the end lip 17″ in the web running direction on the web W running side increases, it is less advantageous for the formation of bead. When the length of the end lip 17″ varies with arbitrary sites in the crosswise direction of the slot die, the resulting slight external disturbance makes the bead unstable. Accordingly, the change of the length of the end lip 17″ in the crosswise direction of the slot die is preferably predetermined to be 20 μm or less.

Referring to the material of the end lip 17″ of the slot die, a material such as stainless steel undergoes sagging during die machining, making it impossible to satisfy the desired precision of the end lip 17″ even if the length of the end lip 17″ of the slot die is from 30 to 100 μm in the web running direction as previously mentioned.

Accordingly, in order to maintain a high working precision, it is important to use an ultrahard material as disclosed in Japanese Patent No. 2,817,053. In some detail, at least the end lip 17 of the slot die is preferably made of an ultrahard alloy comprising carbide crystals having an average particle diameter of 5 μm or less bonded thereto.

Examples of the ultrahard alloy include those obtained by bonding carbide crystallites such as tungsten carbide (hereinafter referred to as “WC”) with a binding metal such as cobalt. As the binding metal there may be used titanium, tantalum, niobium or mixture thereof besides cobalt. The average particle diameter of WC crystallites is more preferably 3 μM or less.

In order to realize a high precision spreading, the aforementioned length of the end lip 17″ on the side where the web is running and the dispersion of the gap between the end lip 17″ and the web in the crosswise direction of the slot die, too, are important factors. The combination of the two factors, i.e., straightness such that the change of gap can be somewhat inhibited is preferably attained. More preferably, the straightness of the end lip 17″ with respect to the backup roller 11″ is attained such that the change of the gap in the crosswise direction of the slot die is not greater than 5 μm.

### <Coating Speed>

By attaining the aforementioned precision of the backup roll and end lip, the coating method which is preferably used in the invention can provide a coat layer having a stable thickness during high speed spreading. Further, since the coating method of the invention involves premeasurement process, a coat layer having a stable thickness can be easily assured even during high speed coating (or high speed spreading).

For the coating solution to be spread in a small amount as in the anti-reflection film of the invention, the coating method of the invention allows a high speed spreading with a good stability of layer thickness. Other coating methods allow spreading. However, dip coating method unavoidably requires the oscillation of the coating solution in the liquid receiving tank, causing the occurrence of stepwise unevenness. Reverse roll coating method and microgravure coating method can easily cause the occurrence of stepwise unevenness due to eccentricity or deflection of the roll related to spreading. Microgravure coating method can easily cause the occurrence of spread unevenness due to the preparation precision of the gravure roll or the change of the roll or blade with time due to contact of the blade with the gravure roll. Since these coating methods involve postmeasurement process, a stable layer thickness can be difficulty assured. The preparation method of the invention is preferably used to spread the coating solution at a rate of 25 m/min from the standpoint of productivity.

### <Wet Spread>

In order to form the hard coat layer, the aforementioned coating solution is preferably spread over the substrate film directly or with the interposition of other layers to a wet thickness of from 6 to 30 μm. In the case where the hard coat layer is provided with light-scattering properties, the wet thickness is preferably from 3 to 20 μm because the sensitivity of detection of drying unevenness is raised. Further, in the case where a low refractive index layer, a middle refractive index layer and a high refractive index layer are formed, the coating compositions are preferably spread over the hard coat layer directly or with the interposition of other layers to a wet thickness of from 1 to 10 μm, more preferably from 2 to 5 μm.

### (Drying)

The coating solution of hard coat layer and low refractive index layer which have been spread over the substrate film directly or with the interposition of other layers is then conveyed over the web to a heated zone so that it is dried to remove the solvent. During this procedure, the temperature of the drying zone is preferably from 25° C. to 140° C. The former half of the drying zone preferably has a relatively low temperature. The latter half of the drying zone preferably has a relatively high temperature. However, the temperature of the drying zone is preferably not higher than the temperature at which the components other than the solvent contained in the coating composition of the various layers begin to evaporate. For example, some of the commercially available photoradical generators to be used in combination with the ultraviolet-curing resin evaporate in an amount of sores of percentage in several minutes in a 120° C. hot air flow. Some monofunctional or bifunctional acrylate monomers undergo evaporation in a 100° C. hot air flow. In this case, the temperature of the drying zone is preferably a temperature at which the components other than the solvent contained in the coating composition of the various layers begin to evaporate as previously mentioned.

The drying air to be used after the spreading of the coating composition of the various layers over the substrate film flows preferably at a rate of from 0.1 to 2 m/sec over a zone having a solid content concentration of from 1 to 50% to prevent the occurrence of drying unevenness.

After the spreading of the coating composition of the various layers over the substrate film, the difference in temperature between the conveying roll in contact with the side of the substrate film opposite the coated surface thereof and the substrate film in the drying zone is preferably from 0° C. to 20° C. so that the occurrence of drying unevenness due to heat conduction unevenness on the conveying roll can be prevented.

### (Curing)

The method of curing the hard coat layer and the low refractive index layer of the invention and the middle refractive index layer and the high refractive index layer to be formed as necessary will be described hereinafter.

The hard coat layer and the low refractive index layer of the invention and the middle refractive index layer and the high refractive index layer to be formed as necessary are formed by passing the coat layers on the web through zones for curing the coat layers by a method involving at least any of irradiation with ionized radiation and heating after the solvent drying zone. For example, in the case where the coat layers are cured by irradiation with ultraviolet rays, these coat layers are preferably irradiated with ultraviolet rays from an ultraviolet lamp at a dose of from 10 mJ/cm² to 1,000 mJ/cm². During this procedure, the distribution of dose over the range between the two ends in the crosswise direction of web preferably shows a proportion of from 50% to 100%, more preferably from 80% to 100% based on the central maximum dose. The term “ionized radiation” as used herein has a normally used meaning and indicates a radiation which causes excitation or ionization when transmitted by a material, i.e., particle beam and electromagnetic wave also singly called radiation, e.g., alpha rays, beta rays, gamma rays, high energy particle beam, neutron radiation, electron ray, light beam (ultraviolet rays and visible light). Ionized radiations which are particularly preferred in the invention are ultraviolet rays and visible light.

The oxygen concentration during curing is preferably 15 vol-% or less, more preferably 1 vol-% or less, even more preferably 0.3 vol-% or less. When the oxygen concentration during curing is more than 15 vol-%, the deactivation of radical by oxygen becomes remarkable for the reason that the thickness of the various layers of the invention which have been dried to remove the solvent is as thin as from 0.1 μm to scores of micrometers (great surface area per volume), resulting in the fatal deterioration of the scratch resistance of the cured layer, that is, scratch resistance described later, and the partial swelling or dissolution of the surface of the cured layer followed by interfacial mixing that deteriorates reflecting properties.

In order to control the oxygen concentration during curing as mentioned above, the air is preferably purged with nitrogen gas or the like to reduce the oxygen concentration.

In the case where the percent curing (100—content of functional group residue) of the hard coat layer is a value of less than 100%, when the percent curing of the hard coat layer after the curing of a low refractive index layer of the invention thereon by any of irradiation with ionized radiation and application of heat is higher than that developed before the provision of the low refractive index layer, the adhesion between the hard coat layer and the low refractive index layer can be improved to advantage.

The anti-reflection film of the invention thus produced can be used to prepare a polarizing plate which is then used in a liquid crystal display. In this case, the polarizing plate is disposed on the outermost surface of the display with an adhesive layer provided on one side thereof. The anti-reflection film of the invention is preferably used as at least one of two sheets of protective film between which the polarizing film in the polarizing plate is interposed.

The anti-reflection film of the invention can also act as a protective film to reduce the production cost of the polarizing plate. Further, the anti-reflection film of the invention can be used as an outermost layer to prevent the reflection of external light rays, etc., making it possible to provide a polarizing plate excellent also in scratch resistance, stainproofness, etc.

In order to use the anti-reflection film of the invention as one of two sheets of surface protective film for polarizing plate to prepare a polarizing plate, the anti-reflection film is preferably subjected to hydrophilicization on the side of the transparent support opposite the anti-reflection structure, i.e., on the side thereof where it is stuck to the polarizing film to improve the adhesion of the adherend surface thereof.

### (Saponification)

### (1) Alkaline Solution Dipping Method

This is a method which comprises dipping the anti-reflection film in an alkaline solution under proper conditions to saponify the entire surface of the film having reactivity with alkali. This method is advantageous in cost because it requires no special facilities. On the other hand, this method cannot be applied to the case where the anti-reflection film comprises a layer having a low alkali resistance such as sol-gel low refractive index layer. The alkaline solution is preferably an aqueous solution of sodium hydroxide. The concentration of the alkaline solution is preferably from 0.5 to 3 N, particularly from 1 to 2 N. The temperature of the alkaline solution is preferably from 30° C. to 70° C., particularly from 40° C. to 60° C.

The aforementioned combination of saponifying conditions is preferably a combination of relatively mild conditions but can be predetermined by the material and configuration of the anti-reflection film and the target contact angle.

It is preferred that the anti-reflection film which has been dipped in the alkaline solution be thoroughly washed with water or dipped in a dilute acid to neutralize the alkaline component so that the alkaline component is not left in the film.

When the anti-reflection film is saponified, the transparent support is hydrophilicized on the side thereof opposite the anti-reflection layer. The protective film for polarizing plate is used in such an arrangement that the hydrophilicized surface of the transparent support comes in contact with the polarizing film.

The hydrophilicized surface of the transparent support is effective for the improvement of the adhesion to the adhesive layer mainly composed of polyvinyl alcohol.

Referring to saponification, the contact angle of the surface of the transparent support on the side thereof opposite the anti-reflection layer with respect to water is preferably as small as possible from the standpoint of adhesion to the polarizing film. On the other hand, since the dipping method is subject to damage by alkali even on the surface of the transparent support on the anti-reflection layer side thereof, it is important to use minimum required reaction conditions. In the case where as an index of damage of anti-reflection layer by alkali there is used the contact angle of the surface of the transparent support on the side thereof opposite the anti-reflection layer, i.e., on the side on which it is stuck to the polarizing film of the anti-reflection film with respect to water, the contact angle is preferably from 10° to 500, more preferably from 30° to 50°, even more preferably from 40° to 50°, if the support is a triacetyl cellulose film in particular. When the contact angle is 50° or more, there arises a problem with contact with the polarizing film to disadvantage. On the contrary, when the contact angle is 100 or less, the resulting anti-reflection layer doesn't undergo too much damage and is not subject to loss of physical strength and light-resistance.

### (2) Alkaline Solution Coating Method

As a method of avoiding the damage of the anti-reflection layer in the aforementioned dipping method there is preferably used an alkaline solution coating method which comprises spreading an alkaline solution only over the surface of the transparent support on the side thereof opposite the anti-reflection layer, and heating, rinsing and drying the coat layer under proper conditions. The term “spreading” as used herein is meant to indicate that the alkaline solution or the like comes in contact with only the surface of the transparent support to be saponified. Besides spreading, spraying and contact with a belt or the like impregnated with an alkaline solution are included. Since the use of these methods requires the provision of separate facilities and steps for spreading the alkaline solution, the dipping method (1) is preferred from the standpoint of cost. However, since the coating method involves the contact with only the surface of the transparent support to be saponified, it is advantageous in that the opposite side of the transparent support can be made of a material which is easily affected by alkaline solution. For example, the vacuum deposit or sol-gel layer is subject to various effects such as corrosion, dissolution and exfoliation by alkaline solution and is preferably not formed by the dipping method but may be formed by the coating method without any problems because it requires no contact with the alkaline solution.

Both the aforementioned saponification methods (1) and (2) can be conducted after the formation of the various layers on the support unwound from the roll. Therefore, these saponification methods can be each conducted as a continuous step following the aforementioned step of producing the anti-reflection film. Further, by subsequently conducting the step of sticking the film to a polarizing film of continuous length unwound, the polarizing plate can be prepared more efficiently than the similar process conducted in the form of sheet.

### (3) Method Which Comprises Saponifying Anti-Reflection Film Protected by Laminate Film

In the case where the hard coat layer and/or low refractive index layer has an insufficient resistance to alkaline solution as in the aforementioned method (2), a method may be effected which comprises laminating the hard coat layer having a low refractive index layer formed thereon with a laminate film on the low refractive index layer side thereof, dipping the laminate in an alkaline solution to hydrophilicize only the triacetyl cellulose side, which is opposite the low refractive index layer side, and then peeling the laminate film off the low refractive index layer. In accordance with this method, too, hydrophilicization required only for protective film for polarizing plate can be made on only the side of the triacetyl cellulose film opposite the anti-reflection layer without any damage on the hard coat layer and low refractive index layer. As compared with the aforementioned method (2), the method (3) involves the disposal of the laminate film but is advantageous in that it requires no special apparatus for spreading an alkaline solution.

(4) Method Which Comprises Dipping the Laminate in an Alkaline Solution after the Formation of Hard Coat Layer

In the case where the laminate is resistant to an alkaline solution up to the hard coat layer but the low refractive index layer is insufficiently resistant to an alkaline solution, the laminate may be dipped in an alkaline solution after the formation of the hard coat layer so that the both sides thereof are hydrophilicized, followed by the formation of the low refractive index layer on the hard coat layer. This method requires complicated productions steps but is advantageous in that the adhesion between the hard coat layer and the low refractive index layer can be enhanced if the low refractive index layer is a layer having a hydrophilic group such as fluorine-containing sol-gel layer.

(5) Method which Comprises Forming an Anti-Reflection Film on a Saponified Triacetyl Cellulose Film

A hard coat layer and a low refractive index layer may be formed on any one side of a triacetyl cellulose film which has been previously saponified by dipping in an alkaline solution directly or with other layers interposed therebetween. When the triacetyl cellulose film is dipped in an alkaline solution to undergo saponification, the adhesion between the hard coat layer or other layers and the triacetyl cellulose film which has been hydrophilicized by saponification can be deteriorated. In this case, the triacetyl cellulose film which has been saponified may be subjected to treatment such as corona discharge and glow discharge only on the side thereof where the hard coat layer or other layers are formed so that the hydrophilicized surface can be removed before the formation of the hard coat layer or other layers. Further, in the case where the hard coat layer or other layers have a hydrophilic group, the interlayer adhesion may be good.

A polarizing plate comprising the anti-reflection film of the invention and a liquid crystal display comprising the polarizing plate will be described hereinafter.

### (Polarizing Plate)

A preferred polarizing plate of the invention has an anti-reflection film of the invention as at least one of the protective films for polarizing film (polarizing plate protective film). The polarizing plate protective film preferably has a contact angle of from 10° to 50° with respect to water on the surface of the transparent support opposite the anti-reflection structure side, i.e., on the side thereof where it is stuck to the polarizing film as previously mentioned.

The use of the anti-reflection film of the invention as a protective film for polarizing plate makes it possible to prepare a polarizing plate having an anti-reflection capacity excellent in physical strength and light-resistance and drastically reduce the cost and thickness of display.

Further, the constitution of a polarizing plate comprising an anti-reflection film of the invention as one protective film for polarizing plate and an optical compensation film having an optical anisotropy described later as the other protective film for polarizing film makes it possible to prepare a polarizing plate that provides a liquid crystal display with an improved contrast in the daylight and a drastically raised horizontal and vertical viewing angle.

### (Optical Compensation Film)

The polarizing plate may comprise an optical compensation layer (retarder layer) incorporated therein to improve the viewing angle properties of a liquid crystal display screen.

As the optical compensation layer there may be used any material known as such. In respect to the rise of viewing angle, there is preferably used an optical compensation layer having an optically anisotropic layer made of a compound having a discotic structural unit wherein the angle of the discotic compound with respect to the transparent support changes with the distance from the transparent support.

This angle preferably changes with the rise of the distance from the transparent support side of the optically anisotropic layer.

In other words, as a preferred polarizing plate there may be used a polarizing plate wherein the films other than anti-reflection film among the surface protective films are optical compensation films having an optical compensation layer comprising an optically anisotropic layer on the opposite side of the surface protective film from the polarizing film, the optically anisotropic layer is a layer made of a compound having a discotic structural unit, the disc surface of the discotic structure unit is disposed obliquely to the surface of the surface protective film and the angle of the disc surface of the discotic structure unit with respect to the surface of the surface protective film changes in the depth direction of the optically anisotropic layer.

In the case where the optical compensation layer is used as a protective film for polarizing film, the optical compensation layer is preferably saponified on the side thereof on which it is stuck to the polarizing film. The saponification of the optical compensation layer is preferably conducted in the same manner as mentioned above.

Other preferred embodiments include a configuration wherein the optically anisotropic layer further comprises a cellulose ester, a configuration wherein an alignment layer is formed interposed between the optically anisotropic layer and the transparent support, and a configuration wherein the transparent support of the optical compensation film having an optically anisotropic layer has an optically negative monoaxiality and an optical axis along the line normal to the surface thereof.

### (Polarizing Film)

As the polarizing film there may be used a known polarizing film or a polarizing film cut out of a polarizing film of continuous length having an absorption axis which is neither parallel to nor perpendicular to the longitudinal direction. The polarizing film of continuous length having an absorption axis which is neither parallel to nor perpendicular to the longitudinal direction is prepared by the following method.

This is a polarizing film stretched by tensing a continuously supplied polymer while being retained at the both ends thereof by a retainer. In some detail, the polarizing film can be produced by a stretching method which comprises stretching the film by a factor of from 1.1 to 20.0 at least in the crosswise direction in such a manner that the difference in longitudinal progress speed of retainer between at both ends is 3% or less and the direction of progress of film is deflexed with the film retained at the both ends thereof such that the angle of the direction of progress of film at the outlet of the step of retaining both ends of the film with respect to the substantial direction of film stretching is from 20° to 70°. In particular, those obtained under the aforementioned conditions wherein the inclination angle is 45° are preferably used from the standpoint of productivity.

For the details of the method of stretching polymer film, reference can be made to JP-A-2002-86554, paragraphs (0020)-(0030).

### (Liquid Crystal Display)

The anti-reflection film of the invention can be applied to an image display such as liquid crystal display (LCD), plasma display panel (PDP), electroluminescence display (ELD) and cathode ray tube display (CRT). The anti-reflection film of the invention has a transparent support and thus can be bonded to the image display surface of the image display on the transparent support side thereof.

The anti-reflection film of the invention, if used as one of polarizing film surface protective films, is preferably used in transmission type, reflection type or semi-transmission type liquid crystal displays of mode such as twisted nematic (TN), supertwisted nematic (STN), vertical alignment (VA), in-plane switching (IPS) and optically compensated bend cell (OCB).

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode, CAP mode) (as disclosed in Preprints of Symposium on Japanese Liquid Crystal Society Nos. 58 to 59, 1988 and (4) liquid crystal cell of SURVALVAL mode (as reported in LCD International 98).

An OCB mode liquid crystal cell is a liquid crystal cell of bend alignment mode wherein rod-shaped liquid crystal molecules are oriented in substantially opposing directions (symmetrically) from the upper part to the lower part of the liquid crystal cell as disclosed in U.S. Pat. Nos. 4,583,825 and 5,410,422. In the OCB mode liquid crystal cell, rod-shaped liquid crystal molecules are oriented symmetrically with each other from the upper part to the lower part of the liquid crystal cell. Therefore, the bend alignment mode liquid crystal cell has a self optical compensation capacity. Accordingly, this liquid crystal mode is also called OCB (optically compensated bend) liquid crystal mode. The bend alignment mode liquid crystal display is advantageous in that it has a high response.

In ECB mode liquid crystal cell, rod-shaped liquid crystal molecules are oriented substantially horizontal when no voltage is applied thereto. The ECB mode liquid crystal cell is used mostly as a color TFT liquid crystal display. For details, reference can be made to many literatures, e.g., “EL, PDP, LCD Displays”, Toray Research Center, 2001.

For TV or IPS mode liquid crystal displays in particular, the use of an optical compensation sheet having a viewing angle expanding effect as one of two sheets of polarizing film protective film opposite the anti-reflection film of the invention makes it possible to obtain a polarizing plate having both anti-reflection effect and viewing angle expanding effect by the thickness of only one sheet of polarizing plate as disclosed in JP-A-2001-100043.

### EXAMPLE

The invention will be further described in the following examples, but the invention is not limited thereto. The terms “parts” and “%” as used hereinafter are by weight unless otherwise specified.

### (Preparation of Transparent Support 1)

### <Preparation of Dope>

As the dope materials there were used the following formulations.

| | | |
|---|---|---|
| Cellulose triacetate (acetylation degree: 60.5%) | 20 | parts by weight |
| Methyl acetate | 58 | parts by weight |
| Acetone | 5 | parts by weight |
| Methanol | 5 | parts by weight |
| Ethanol | 5 | parts by weight |
| n-Butanol | 5 | parts by weight |
| Plasticizer A: ditrimethylol propane tetraacetate | 1.2 | parts by weight |
| Plasticizer B: triphenyl phosphate | 1.2 | parts by weight |
| Ultraviolet absorber a: | 0.2 | parts by weight |
| (2,4-bis-(n-octylthio)-6-(4-hydroxy-3,5-di-tert- | | |
| butylanilino)-1,3,5-triazine | | |
| Ultraviolet absorber b: | 0.2 | parts by weight |
| 2(2′-hydroxy-3′,5′-di-tert-butylphenyl)-5- | | |
| chlorobenzotriazole | | |
| Ultraviolet absorber c: | 0.2 | parts by weight |
| (2(2′-hydroxy-3′,5′-di-tert-amylphenyl)-5- | | |
| chlorobenzotriazole | | |
| Release agent a: | 0.02 | parts by weight |
| C₁₂H₂₅OCH₂CH₂O—P(═O)—(OK)₂ | | |
| Release agent b: citric acid | 0.02 | parts by weight |
| Particulate material: | 0.05 | parts by weight |
| slicon dioxide (particle diameter: 20 nm; | | |
| Mohs hardness: about 7) | | |

The mixed solvent was put in a mixing tank. TAC was then put in the mixing tank. While the temperature of the solvent was being kept at a range of from 35° C. to 40° C., the content of the mixing tank was then stirred by an agitating blade for 30 minutes to obtain a crude solution. Thereafter, additives were properly added to the solution. The mixture was then stirred for 60 minutes. During this procedure, too, the temperature of the solution was kept at a range of from 30° C. to 32° C. When it was visually confirmed that there had been left no insoluble matters, a dope 11′ was then obtained.

### <Casting>

The dope 11′ was put in a mixing tank 12 from which it was then fed into a casting die 16 by a feed pump 14. The dope 11′ was then casted in such a manner that the dry thickness of the film reached 80 μm. The width of the cast film was 1,600 mm. The drying air 26 had a temperature of 35° C. and was allowed to flow over the cast layer 25 at a rate of 9 m/s. The casting speed of the casting band 23 was 0.5 m/s. The film 28 was peeled off the casting band 23 while being supported on the peeling roller 27. The conveying speed of the film 28 over the roller 40 was 9.5 m/s. The stress Sx in the conveying direction was measured by a tension meter 29. The result was 1.92 MPa.

The film 28 was conveyed into the tenter chamber 50 where it was then stretched by a tenter device 51. Drying air 54 and drying air 55 were allowed to flow into the tenter chamber 50 by drying air suppliers 52, 53 such that the average temperature in the tenter device 51 reached 130° C. The content of residual solvents in the film 28 at the time of initiation of stretching (extreme upstream along the stretching portion 51b in FIG. 4) was 21% by weight. The stretching was effected by a factor of 20% at a rate of 100%/min. During stretching, the surface temperature of the film (hereinafter referred to as “film surface temperature”) was measured by a radiation pyrometer. The result was 116° C. The crosswise maximum stress Syₘₐₓ calculated from the value measured by a strain indicator 87 was 54 MPa. The ratio (Sy/Sx) of the stress Sx in the conveying direction to the crosswise stress Sy was 28. The time during which the film had been conveyed from the inlet 76 of the tenter device to the outlet 77 of the tenter device was 0.81 minutes. Shortly after stretching, thermal relaxation was then effected in a heat treatment zone 51c at 115° C. for 6 seconds with the width of the film being kept. Thereafter, the film 28 was conveyed into a drying chamber 60 where it was then dried for 32 minutes. Drying air 64 and drying air 65 were supplied from drying air suppliers 62 and 63 such that the average temperature in the drying chamber 60 reached 120° C. Finally, the film 28 was wound by a winding machine 66 to form a roll. The transparent support 1 thus prepared was then visually evaluated for flatness. As a result, the film 28 showed drastic improvements in flatness as compared with the related art products and thus showed little or no visible wrinkling.

### (Preparation of Transparent Support 2)

A transparent support 2 was prepared in the same manner as in the preparation of the transparent support 1 except that Syₘₐₓ was 2 MPa and the ratio (Sy/Sx) of crosswise stress Sy to stress Sx in the conveying direction was 1. The transparent support 2 thus prepared was then visually detected for surface conditions at an elevation of about 45° in the longitudinal direction and crosswise direction with a fluorescent lamp being reflected thereon. As a result, the transparent support 2 showed so poor a flatness that wrinkling could be definitely confirmed.

### (Synthesis of Perfluoroolefin Copolymer (1))

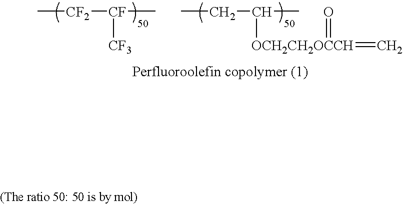

Into an autoclave with stainless agitator having an internal capacity of 100 ml were charged 40 ml of ethyl acetate, 14.7 g of hydroxyethyl vinyl ether and 0.55 g of dilauroyl peroxide. The air in the system was removed and replaced by nitrogen gas. 25 g of hexafluoropropylene (HFP) was introduced into the autoclave which was then heated to 65° C. The pressure in the autoclave at the time when the temperature in the autoclave reached 65° C. was 0.53 MPa (5.4 kg/cm²). The reaction then continued at the same temperature for 8 hours. When the pressure in the autoclave reached 0.31 MPa (3.2 kg/cm²), heating was then suspended so that the autoclave was allowed to cool. When the internal temperature of the autoclave reached room temperature, the unreacted monomers were then removed. The autoclave was then opened to withdraw the reaction solution. The reaction solution thus obtained was then poured into a large excess of hexane. By removing the solvent by decantation, the precipitated polymer was withdrawn. The polymer thus obtained was dissolved in a small amount of ethyl acetate. The solution was then twice reprecipitated from hexane to remove thoroughly the residual monomers. After dried, a polymer was obtained in an amount of 28 g. Subsequently, 20 g of the polymer thus obtained was dissolved in 100 ml of N,N-dimethylacetamide. To the solution was then added dropwise 11.4 g of acrylic acid chloride under ice cooling. The mixture was then stirred at room temperature for 10 hours. To the reaction solution was then added ethyl acetate. The reaction solution was then washed with water. The organic phase was then extracted. The residue was then concentrated. The polymer thus obtained was then reprecipitated from hexane to obtain 19 g of a perfluoroolefin copolymer (1). The refractive index of the polymer thus obtained was 1.421.

### (Preparation of Organosilane Sol A)

Into a reaction vessel equipped with an agitator and a reflux condenser were charged 120 parts by weight of methyl ethyl ketone, 100 parts by weight of acryloyl oxypropyl trimethoxysilane “KBM-5103” (produced by Shin-Etsu Chemical Co., Ltd.) and 3 parts by weight of diisopropoxy aluminum ethyl acetoacetate (trade name: Kelope EP-12, produced by Hope Chemical Co., Ltd.). The mixture was then stirred. To the mixture were then added 30 parts by weight of deionized water. The reaction mixture was allowed to undergo reaction at 60° C. for 4 hours, and then allowed to cool to room temperature to obtain an organosilane sol. The compound thus obtained had a weight-average molecular weight of 1,600. The proportion of components having a molecular weight of from 1,000 to 20,000 in the oligomer components or higher components was 100%. The gas chromatography of the reaction product showed that none of the acryloyloxy propyl trimethoxysilane as raw material remained.

### (Preparation of Organosilane Sol B)

An organosilane sol B was prepared in the same manner as in the preparation of the organosilane sol A except that 25 parts by weight of tetraethoxysilane and 75 parts by weight of tridecafluorooctyl trimethoxysilane were used instead of 100 parts by weight of acryloyloxy propyl trimethoxysilane.

### (Preparation of Hard Coat Layer Coating Solution A)

50 g of a mixture of pentaerythritol triacrylate and pentaerythritol tetraacrylate (KAYARAD PET-30 (trade name), produced by NIHON KAYAKU CO., LTD.) was diluted with 38.5 g of toluene. To the solution was then added 2 g of a polymerization initiator (Irgacure 184, produced by Ciba Specialty Chemicals Co., Ltd.). The mixture was then stirred. The solution was spread, and then irradiated with ultraviolet rays to obtain a coat layer having a refractive index of 1.51.

To the solution were then added 1.7 g of a 30% toluene dispersion of a particulate crosslinked polystyrene (refractive index: 1.60; SX-350, produced by Soken Chemical & Engineering Co., Ltd.) which had been subjected to dispersion at 10,000 rpm by a polytron dispersing machine for 20 minutes and 13.3 g of a 30% toluene dispersion of a particulate crosslinked acryl-styrene having an average particle diameter of 3.5 μm (refractive index: 1.55, produced by Soken Chemical & Engineering Co., Ltd.). Finally, to the mixture were added 0.75 g of the aforementioned fluorine-based polymer (P-7) and 10 g of a silane coupling agent (KBM-5103, produced by Shin-Etsu Chemical Co., Ltd.) to complete the desired solution.

The aforementioned mixture was filtered through a polypropylene filter having a pore diameter of 30 μm to prepare a hard coat layer coating solution A. The wet spread of the coating solution was 19.5 cc/m².

### (Preparation of Hard Coat Layer Coating Solution B)

285 g of a commercially available zirconia-containing UV-curing hard coating solution (DeSolite Z7404, produced by JSR Co., Ltd.; solid content concentration: approx. 61%; ZrO₂ content in solid content: approx. 70%; polymerizable monomer; polymerization initiator contained) and 85 g of a mixture of dipentaerythritol pentaacrylate and dipentaerythritol hexaacrylate (DPHA, produced by NIHON KAYAKU CO., LTD.) were mixed. The mixture was then diluted with 60 g of methyl isobutyl ketone and 17 g of methyl ethyl ketone. To the mixture was then added 28 g of a silane coupling agent (KBM-5103, produced by Shin-Etsu Chemical Co., Ltd.). The mixture was then stirred. The solution thus prepared was spread, and then ultraviolet-cured to obtain a coat layer having a refractive index of 1.61.

To the solution was then added 35 g of a dispersion obtained by dispersing a 30% methyl isobutyl ketone dispersion of a classified reinforced crosslinked particulate PMMA having an average particle diameter of 3.0 μm (refractive index: 1.49; MXS-300, produced by Soken Chemical & Engineering Co., Ltd.) at 10,000 rpm by a polytron dispersing machine for 20 minutes. Subsequently, to the mixture was added 90 g of a dispersion obtained by dispersing a 30% methyl ethyl ketone dispersion of a particulate silica having an average particle diameter of 1.5 μm (refractive index: 1.46, SEAHOSTER KE-P150, produced by NIPPON SHOKUBAI CO., LTD.) at 10,000 rpm by a polytron dispersing machine for 30 minutes. The mixture was then stirred to complete the desired solution.

The aforementioned mixture was filtered through a polypropylene filter having a pore diameter of 30 μm to prepare a hard coat layer coating solution B. The wet spread of the coating solution was 10.0 cc/m².

### (Preparation of Hard Coat Layer Coating Solution C)

| | |
|---|---|
| KAYARAD DPCA-20, produced by NIHON | 100 parts by weight |
| KAYAKU CO., LTD. (mixture by weight of | |
| partly caprolactone-modified dipentaerythritol | |
| hexaacrylates; 2 mols added on the average | |
| (unit/mol)) | |
| Methyl ethyl ketone | 90 parts by weight |
| Cyclohexanone | 10 parts by weight |
| Irgacure 907 (produced by Ciba Speciality | 3 parts by weight |
| Chemicals Co., Ltd.) | |

These components were mixed, stirred, and then filtered through a polypropylene filter having a pore diameter of 0.4 μm. The wet spread of the coating solution was 20.0 cc/m².

### (Preparation of Dispersion of Particulate Titanium Dioxide)

| | |
|---|---|
| MPT-129C produced by ISHIHARA SANGYO | 57.1 parts by weight |
| KAISHA, LTD. (TiO₂:Co₃O₄:Al₂O₃:ZrO₂ = | |
| 90.5:3.0:4.0:0.5 by weight) | |
| Dispersant described below | 38.6 parts by weight |
| Cyclohexanone | 704.3 parts by weight |

These components were mixed, and then dispersed by a dinomill until a weight-average particle diameter of 70 nm was reached.

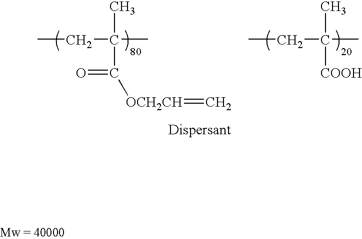

### (Preparation of Middle Refractive Index Layer Coating Solution A)

| | |
|---|---|
| Titanium dioxide dispersion described above | 88.9 parts by weight |
| KAYARAD DPHA, produced by NIHON | 58.4 parts by weight |
| KAYAKU CO., LTD. | |
| Irgacure 907 (produced by Ciba Specialty | 4.0 parts by weight |
| Chemicals Co., Ltd.) | |
| Kayacure DETX, produced by NIHON | 1.3 parts by weight |
| KAYAKU CO., LTD. | |
| Methyl ethyl ketone | 482.4 parts by weight |
| Cyclohexanone | 1,869.8 parts by weight |

These components were mixed, stirred, and then filtered through a polypropylene filter having a pore diameter of 0.4 μm. The wet spread of the coating solution thus prepared was 3.5 cc/m².

### (Preparation of High Refractive Index Layer Coating Solution A)

| | |
|---|---|
| Titanium dioxide dispersion described above | 586.8 parts by weight |
| KAYARAD DPHA, produced by NIHON | 47.9 parts by weight |
| KAYAKU CO., LTD. | |
| Irgacure 907 (produced by Ciba Specialty | 4.0 parts by weight |
| Chemicals Co., Ltd.) | |
| Kayacure DETX, produced by NIHON | 1.3 parts by weight |
| KAYAKU CO., LTD. | |
| Methyl ethyl ketone | 455.8 parts by weight |
| Cyclohexanone | 1,427.8 parts by weight |

These components were mixed, stirred, and then filtered through a polypropylene filter having a pore diameter of 0.4 μm. The wet spread of the coating solution thus prepared was 3.5 cc/m².

### (Preparation of Hollow Silica Dispersion)

To 500 parts by weight of a hollow particulate silica sol (isopropyl alcohol silica sol, CS60-IPA, produced by CATALYSTS & CHEMICALS IND. CO., LTD.; average particle diameter: 60 nm; shell thickness: 10 nm; silica concentration: 20%; refractive index of particulate silica: 1.31) were added 30 parts by weight of acryloyloxy propyl trimethoxysilane and 1.5 parts by weight of diisopropoxy aluminum ethyl acetoacetate (trade name: Kelope EP-12, produced by Hope Chemical Co., Ltd.). The mixture was then stirred. To the mixture were then added 9 parts by weight of deionized water. The reaction mixture was allowed to undergo reaction at 60° C. for 8 hours, and then allowed to cool to room temperature. To the mixture were then added 1.8 parts by weight of acetyl acetone to obtain a hollow silica dispersion. The hollow silica dispersion thus obtained had a solid content concentration of 18% by weight and showed a refractive index of 1.31 after dried.

### (Preparation of Low Refractive Index Layer Coating Solution A)

| | |
|---|---|
| JTA113, produced by JSR Co., Ltd. | 13.0 parts by weight |
| (hydroxyl group-containing thermosetting | |
| fluorine-containing polymer; 6% MEK solution) | |
| MEK-ST-L, produced by NISSAN CHEMICAL | 1.2 parts by weight |
| INDUSTRIES, LTD. (silica sol; 60% MEK | |
| dispersion) | |
| Sol A | 0.7 parts by weight |
| MEK (Methyl ethyl ketone) | 5.0 parts by weight |
| Cyclohexanone | 0.6 parts by weight |

These components were mixed, stirred, and then filtered through a polypropylene filter having a pore diameter of 0.4 μm. The wet spread of the coating solution thus prepared was 3.5 cc/m².

(Preparation of Low Refractive Index Layer Coating Solution B)

| | |
|---|---|
| KAYARAD DPHA (produced by NIHON | 1.4 parts by weight |
| KAYAKU CO., LTD.) | |
| Perfluoroolefin copolymer (1) | 5.6 parts by weight |
| Hollow silica dispersion | 20.0 parts by weight |
| RMS-033 (produced by GEKEST) | 0.7 parts by weight |
| Irgacure 907 (produced by Ciba Specialty | 0.2 parts by weight |
| Chemicals Co., Ltd.) | |
| Sol A | 6.2 parts by weight |
| MEK | 305.9 parts by weight |
| Cyclohexanone | 10.0 parts by weight |

These components were mixed, stirred, and then filtered through a polypropylene filter having a pore diameter of 0.4 μm. The wet spread of the coating solution thus prepared was 3.5 cc/m².

### (Preparation of Low Refractive Index Layer Coating Solution C)

| | |
|---|---|
| Organosilane sol B | 10.0 parts by weight |
| X-22-164C | 0.04 parts by weight |
| Dimethylamino benzene | 0.04 parts by weight |
| MEK | 87.0 parts by weight |
| Cyclohexanone | 2.8 parts by weight |

These components were mixed, stirred, and then filtered through a polypropylene filter having a pore diameter of 0.4 μm. The wet spread of the coating solution thus prepared was 3.5 cc/m².

### Examples 1 to 3; Comparative Examples 1 and 2

Anti-reflection films of Examples 1 to 3 and Comparative Examples 1 and 2 were prepared according to the layer configuration and coating method as set forth in Table 1. The conditions of spreading, drying and curing of various layer coating solutions and film saponification in MG (microgravure process) and die coating process will be described below.

TABLE 1

| | | | | Thin optical layer | | | |
|---|---|---|---|---|---|---|---|
| | | Hard coat layer | | Middle | High | Low | |
| | Transparent | Coating | Coating | refractive | refractive | refractive | Coating |
| | support | solution | method | layer | layer | layer | method |
| Example | | | | | | | |
| 1-1 | 1 | A | MG | None | None | A | MG |
| 1-2 | 1 | A | MG | None | None | B | Die coat |
| 1-3 | 1 | A | Die coat | None | None | A | Die coat |
| 2-1 | 1 | B | MG | None | None | A | MG |
| 2-2 | 1 | B | MG | None | None | B | Die coat |
| 2-3 | 1 | B | Die coat | None | None | A | Die coat |
| 3-1 | 1 | C | MG | A | A | A | MG |
| 3-2 | 1 | C | MG | A | A | B | Die coat |
| 3-3 | 1 | C | Die coat | A | A | A | Die coat |
| Comparative | | | | | | | |
| Example | | | | | | | |
| 1-1 | 2 | A | MG | None | None | A | MG |
| 1-2 | 2 | A | Die coat | None | None | A | Die coat |
| 2-1 | 2 | C | MG | A | A | A | MG |
| 2-2 | 2 | C | Die coat | A | A | A | Die coat |

### (1) MG Coating Conditions

Using respective microgravure rolls and doctor blades having different numbers of lines and different depths, a hard coat layer coating solution and optical thin layer coating solutions (middle refractive index layer, high refractive index layer, low refractive index layer) were coated at a rate of 20 m/min and 25 n/min, respectively, with the rotary speed of the gravure roll being adjusted to attain the desired wet spread. The coating width and the effective width were 1,310 mm and 1,280 mm, respectively. The aforementioned conveying speed is the upper limit of conveying speed at which the surface conditions of the coat layer is stabilized. When the conveying speed was not lower than the upper limit, the resulting coat layer was unstable.

### (2) Die Coating Conditions

Referring to the basic conditions, as the slot die 13″ there was used one comprising an upstream lip land having a length I_{UP} of 0.5 mm, a downstream lip land having a length ILO of 50 μm, a slot 16 with an opening having a length of 150 μm in the web running direction and a slot 16″ having a length of 50 mm. The gap between the upstream lip land 18a″ and the web 12″ was 50 μm longer than the gap between the downstream lip land 18b″ and the web 12″ (hereinafter referred to as “overbite length of 50 μm”). The gap GL between the downstream lip land 18b″ and the web W was predetermined to be 50 μm. The gap Gs between the side plate 40b″ of the pressure-reducing chamber 40″ and the web W and the gap GB between the back plate 40a″ and the web W were both predetermined to be 200 μm. These conditions were properly predetermined to fall within the aforementioned preferred ranges according to the physical properties and wet spread of the respective coating solutions. Under these conditions, the hard coat layer and the optical thin layers were coated at a rate of 50 m/min and 60 m/min, respectively. The coating width and the effective width were 1,300 mm and 1,280 mm, respectively. The aforementioned conveying speed is the upper limit of conveying speed at which the surface conditions of the coat layer is stabilized. When the conveying speed was not lower than the upper limit, the resulting coat layer was unstable.

(3) Drying 40° C. drying air was blown onto the coat layer at a flow rate of from 0.1 m/sec to 0.5 m/sec for 40 seconds so that the initial solvent evaporation gradually occurred. Subsequently, 80° C. drying air was blown onto the coat layer at a flow rate of from 1 m/sec to 2 m/sec wherein the flow rate increases from the former half of the drying zone to the latter half of the drying zone for 150 seconds to evaporate the residual solvents.

### (4) Curing

Using a 160 W/cm air-cooled metal halide lamp (produced by EYE GRAPHICS CO., LTD.) while the air in the system was being purged with nitrogen, the coat layers were cured by irradiating with ultraviolet rays at a dose of 50 mJ/cm² for hard coat layer, 300 mJ/cm² for middle refractive index layer, 100 mJ/cm² for high refractive index layer and 800 mJ/cm² for low refractive index layer. Only in the case where the low refractive index layer coating solution A was used, the coat layer which had been irradiated with ultraviolet rays was further heat-cured in a 125° C. post-drying zone for 10 minutes.

### (5) Saponification of Anti-Reflection Film

The aforementioned film which had been coated with the anti-reflection layer coating solution was then subjected to the following saponification.

A 1.5 N aqueous solution of sodium hydroxide was prepared. The aqueous solution thus prepared was then kept at 55° C. A 0.01 N diluted aqueous solution of sulfuric acid was prepared. The aqueous solution thus prepared was then kept at 35° C. The anti-reflection film prepared was dipped in the aforementioned aqueous solution of sodium hydroxide for 2 minutes, and then dipped in water so that the aqueous solution of sodium hydroxide was thoroughly washed away.

Subsequently, the anti-reflection film was dipped in the aforementioned diluted aqueous solution of sulfuric acid for 1 minute, and then dipped in water so that the diluted aqueous solution of sulfuric acid was thoroughly washed away. Finally, the sample was thoroughly dried at 120° C.

In this manner, a saponified anti-reflection film was prepared. Thus, samples of Examples 1 to 3 and Comparative Examples 1 and 2 were obtained.

### Example 4

Hard coat layers of Examples 1 to 3 were formed. The laminates were each then subjected to saponification in the same manner as in Example 1 with no low refractive index layer being provided thereon. Thereafter, the low refractive index layer coating solution C was spread over the hard coat layer by microgravure coating method or die coating method in the same manner as in Example 1, dried, previously cured in a 120° C. heat-curing zone for 8 minutes, and then wound in the form of roll. The roll was then subjected to final curing in a 120° C. atmosphere for 30 minutes to prepare anti-reflection films having light-scattering properties and anti-glare properties (Examples 4-1 to 4-3).

### (Evaluation of Anti-Reflection Film)

The anti-reflection films obtained in Examples 1 to 4 were each then evaluated for the following properties. Further, the anti-reflection films obtained in Comparative Examples 1 and 2 were each evaluated for the same properties.

### (1) Flatness of Film (Wrinkling)

The anti-reflection film was evaluated for flatness according to the following criterion in the following manner. In some detail, an anti-reflection film sample having an area of (total width×1 m length) was laminated with a black film on the side thereof opposite the anti-reflection layer so that it causes no reflection on the back side thereof. Under a point light source turned on in a dark room, the anti-reflection film sample was detected for surface conditions at an elevation of about 45° in the longitudinal direction and crosswise direction.

| | |
|---|---|
| Much wrinkling observed | P |
| Slightly much wrinkling observed | FP |
| Slight but inoffensive wrinkling observed | F |
| Little or no wrinkling | G |
| No wrinkling observed | E |

The results of evaluation show that the samples of Examples 1, 2 and 4 were ranked E (excellent) and the sample of Example 3 was ranked G (good). On the other hand, the samples of Comparative Examples 1 and 2 were ranked FP.

### (2) Unevenness in Interference of Anti-Reflection Film

The anti-reflection film was evaluated for flatness according to the following criterion in the following manner. In some detail, an anti-reflection film sample having an area of (1,280 mm width in the effective width×1 m length) was laminated with a black film on the side thereof opposite the anti-reflection layer so that it causes no reflection on the back side thereof. Under a scattering light source comprising a three-wavelength type white fluorescent lamp (National FPLP27EX-N) covered with a scattering cover turned on in a dark room, the anti-reflection film sample was detected for surface conditions at an elevation of about 45° in various directions. The unevenness in interference of hard coat layer and light interference layer was then evaluated according to the following criterion.

| | |
|---|---|
| Strong unevenness in interference observed | P |
| Slightly strong unevenness in interference observed | FP |
| Slight but inoffensive unevenness observed | F |
| Little or no unevenness in interference observed | G |
| No unevenness in interference observed | E |

The results of evaluation show that the samples of Examples 1, 2 and 4 were ranked E (excellent) and the sample of Example 3 was ranked G (good). On the other hand, all the comparative samples were visually observed to have longitudinally extending streak-shaped unevenness due to wrinkling. In some detail, the sample of Comparative Example 1-1 was ranked FP (fair˜poor) on the part of transparent support. The sample of Comparative Examples 1-2, 2-1 and 2-2 were each ranked FP on the general part and ranked P on some part. On the other hand, all the comparative samples were visually observed to have longitudinally extending streak-shaped unevenness due to wrinkling. In some detail, the sample of Comparative Example 1-1 was ranked FP (fair˜poor) on the part of transparent support. The sample of Comparative Examples 1-2, 2-1 and 2-2 were each ranked FP on the general part and ranked P on some part.

### Example 5

As a protective film for polarizing plate, the anti-reflection films prepare in Examples 1 to 4 were each stuck to one side of a polarizing plate in such an arrangement that it comes in contact with the polarizing film on the side thereof opposite the anti-reflection layer with an adhesive. A saponified triacetyl cellulose film free of coat layer was stuck to the other side of the polarizing plate with an adhesive. In this manner, a polarizing plate having an anti-reflection layer on one side thereof was prepared.

### Example 6

As a protective film for polarizing plate, the anti-reflection films prepare in Examples 1 to 4 were each stuck to one side of a polarizing plate in such an arrangement that it comes in contact with the polarizing film on the side thereof opposite the anti-reflection layer with an adhesive. A viewing angle expanding film having an optical compensation layer (Wide View Film SA 12B, produced by Fuji Photo Film Co., Ltd.) was stuck to the other side of the polarizing plate in such an arrangement that it comes in contact with the polarizing film on the side thereof opposite the optical compensation layer with an adhesive. In this manner, a polarizing plate having an optical compensation layer on one side thereof and an anti-reflection layer on the other was prepared.

### Example 7

The polarizing plate having an optical compensation layer prepared in Example 6 was mounted on a transmission type TN liquid crystal cell in such an arrangement that the optical compensation layer was disposed on the liquid crystal cell side of the polarizing plate on the backlight side of the liquid crystal cell. The polarizing plate having an anti-reflection layer prepared in Example 5 was mounted on the transmission type TN liquid crystal cell in such an arrangement that the anti-reflection layer was disposed on the outermost surface (viewing side). In this manner, a liquid crystal display having an excellent contrast in the daylight, a very wide horizontal and vertical viewing angle, an extremely excellent viewability and a high display quality was obtained. This liquid crystal display was visually observed to show little or no defectives in surface flatness seen at an elevation of 45° due to wrinkling, which defectives are remarkable particularly with the case where a hard coat layer having no light-scattering properties is used.

It will be apparent to those skilled in the art that various modifications and variations can be made to the described preferred embodiments of the invention without departing from the spirit or scope of the invention. Thus, it is intended that the present invention cover all modifications and variations of this invention consistent with the scope of the appended claims and their equivalents.

This application is based on Japanese Patent Application No. JP2004-226897 filed on Aug. 3, 2004, the contents of which is incorporated herein by reference.

### INDUSTRIAL APPLICABILITY

An anti-reflection film according to the invention can be applied to a polarizing plate and an image display such as liquid crystal display (LCD), plasma display panel (PDP), electroluminescence display (ELD) and cathode ray tube display (CRT).

1. An anti-reflection film comprising:
a transparent support; and
a low refractive index layer having a lower refractive index than that of the transparent support,
wherein the transparent support is produced by casting and drying a dope comprising a polymer and a solvent over a belt-shaped support, in which the dope is stretched under conditions:
(a) a maximum stress of the dope in a casting crosswise direction is from 1 MPa to 200 MPa; and
(b) a ratio (Sy/Sx) of a stress Sy in the casting crosswise direction to a stress Sx in a dope conveying direction perpendicular to the casting crosswise direction is from 2 to not 50 during the drying.

2. The anti-reflection film as defined in claim 1, wherein the transparent support is treated with heat at a temperature of from 50° C. to 180° C. and for 1 second to 30 seconds after being stretched.

3. The anti-reflection film as defined in claim 1, wherein a residual solvent content during stretching of the transparent support in the casting crosswise direction is from 30% by weight to 45% by weight.

4. The anti-reflection film as defined in claim 1, wherein the transparent support is a cellulose acylate film having a thickness of from 40 μm to 120 μm.

5. The anti-reflection film as defined in claim 1, wherein
the low refractive index layer is cured layer formed by coating and curing a composition comprising at least a curable composition, the curable composition comprising mainly a fluorine-containing polymer containing: fluorine atoms in an amount of from 35 to 80% by weight; and a crosslinkable or polymerizable group,
the fluorine-containing polymer is a copolymer containing a fluorine-containing vinyl monomer polymerizing unit, a polymerizing unit having a (meth)acryloyl group in its side chain thereof, the copolymer having a main chain of only carbon atoms, and
the low refractive index layer has a refractive index of from 1.30 to 1.55.

6. The anti-reflection film as defined in claim 1, wherein the low refractive index layer is a cured layer formed by coating and curing a curable composition comprising:
(A) a fluorine-containing polymer,
(B) a particulate inorganic material having an average particle diameter of from 30% to not 150% of a thickness of the low refractive index layer and a hollow structure having refractive index of from 1.17 to 1.40; and
(C) at least any of a hydrolyzate and partial condensate of an organosilane represented by formula (1), the organosilane being produced in the presence of an acid catalyst or metal chelate compound:
(R¹⁰)ₘSi(X)₄₋ₘ (1)
wherein R¹⁰ represents a substituted or unsubstituted alkyl or aryl group; X represents a hydroxyl group or hydrolyzable group; and m represents an integer of from 1 to 3.

7. The anti-reflection film as defined in claim 1, wherein
the low refractive index layer is a cured layer formed by coating and curing a curable composition comprising at least one of a hydrolyzate of a compound represented by formula (2) and a dehydration condensate thereof:
(R²)ₙSi(Y)₄₋ₙ (2)
wherein R² represents a substituted or unsubstituted alkyl group, partly or fully fluorine-substituted alkyl group or substituted or unsubstituted aryl group; Y represents a hydroxyl group or hydrolyzable group; and n represents an integer of from 0 to 3, and
the low refractive index layer has a refractive index of from 1.30 to 1.55.

8. The anti-reflection film as defined in claim 1, which further comprises at least one layer of a hard coat layer having no light-scattering properties and a hard coat layer having light-scattering properties, the at least one layer being between the transparent support and the low refractive index layer.

9. A method of producing an anti-reflection film as defined in claim 1, which comprises:
coating a coating solution of at least one anti-reflection layer to a surface of a transparent support from a slot of an end lip of a slot die, wherein a land of the end lip is close to the surface of the transparent support, and the transparent support is continuously running and supported over a backup roller,
wherein the land of the end lip comprises: an upstream lip land disposed upstream from the slot along a running direction of a web; and a downstream lip land disposed downstream from the slot along a running direction of the transparent support,
the downstream lip land has a length in the running direction of from 30 μm to 100 μm, and
a gap between the downstream lip land and the web if from than 30 μm to 120 μm greater than that between the upstream lip land and the web during the coating.

10. A polarizing plate comprising: a polarizing film; and two surface protective films, at least one of the two surface protective films comprising an anti-reflection film defined in claim 1.

11. The polarizing plate as defined in claim 10, wherein
one film of the at least two surface protective films comprises the anti-reflection film,
the other film of the at least two surface protective films is an optical compensation film having an optical compensation layer comprising an optically anisotropic layer on an opposite side of the other film from the polarizing film, and
the optically anisotropic layer comprises a compound having a discotic structural unit, wherein a disc surface of the discotic structure unit is disposed obliquely to a surface of the other film, and an angle of the disc surface of the discotic structure unit with respect to the surface of the other film changes in a depth direction of the optically anisotropic layer.

12. A liquid crystal display comprising at least one sheet of polarizing plate defined in claim 10.
